(19) United States
(12) Patent Application Publication
(10) Pub. No.: US 2024/0172235 A1
(43) Pub. Date: May 23, 2024

(54) METHODS AND SYSTEMS OF NR SIDELINK RESOURCE ALLOCATION FOR POWER SAVING AND BWP OPERATIONS

(71) Applicant: INTERDIGITAL PATENT HOLDINGS, INC., Wilmington, DE (US)

(72) Inventors: Kyle PAN, Saint James, NY (US); Guodong ZHANG, Woodbury, NY (US); Patrick SVEDMAN, Stockholm (SE); Pascal ADJAKPLE, Great Neck, NY (US); Yifan LI, Conshohocken, PA (US); Allan TSAI, Boonton, NJ (US)

(21) Appl. No.: 18/560,124

(22) PCT Filed: May 10, 2022
(86) PCT No.: PCT/US2022/028583

§ 371 Date: Nov. 10, 2023

Related U.S. Application Data
(60) Provisional application No. 63/186,558, filed on May 10, 2021.
(60) Provisional application No. 63/229,736, filed on Aug. 5, 2021.

(51) Int. Cl. H04W 72/20

(52) U.S. Cl. CPC H04W 72/20

(57) ABSTRACT

Methods, apparatus, and systems are described for new radio (NR) sidelink resource allocation, e.g., for power saving and bandwidth part (BWP) operations. According to some aspects, different types of resource sets and signaling (e.g., preferred, non-preferred, resource conflict, etc.) may be considered and it may be indicated to user equipment (UE) which type of resources should be used based on certain criteria, e.g., least power consumption criteria.

### CROSS-REFERENCE TO RELATED APPLICATIONS

This application claims the benefit of U.S. Provisional Application No. 63/186,558, filed May 10, 2021, entitled “Methods and Systems of NR Sidelink Resource Allocation for Power Saving and BWP Operations,” and U.S. Provisional Application No. 63/229,736, filed Aug. 5, 2021, entitled “Methods and Systems of NR Sidelink Resource Allocation for Power Saving and BWP Operations,” the contents of which are hereby incorporated by reference in their entirety.

### BACKGROUND

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

In 3GPP Release 16 (“Rel-16”), basic sidelink (SL) communications have been supported. In a current NR SL system, sensing and resource (re-)selection are based on an assumption that no coordination signaling is available. In 3GPP Release 17 (“Rel-17”), enhancement to reliability and latency is needed.

In Rel-16, bandwidth part (BWP) has been supported for Uu interface to enable power saving and link adaptation, as well as to support UEs with different bandwidths. Basic BWP operation for NR sidelink communications have also been supported in which only one BWP can be configured and active for SL. To benefit from power saving due to bandwidth adaptation for SL, there is a need for advanced BWP operations.

NR sidelink resource allocation and BWP operations may encompass a wide variety of scenarios, servers, gateways, and devices, such as those described in, for example: 3GPP TR 22.886 Study on enhancement of 3GPP Support for 7G V2X Services, Release 16, V16.2.0; and 3GPP TS 22.186 Enhancement of 3GPP support for V2X scenarios (Stage 1), Release 16, V16.2.0.

### SUMMARY

Described herein are methods, apparatus, and systems of NR sidelink resource allocation for power saving and BWP operations.

According to some aspects, an apparatus may include one or more of a gNB or a UE. The apparatus may include a processor, communications circuitry, and a memory. The memory may store instructions that, when executed by the processor, cause the apparatus to perform one or more operations. According to some aspects, one or more steps may be included in a method.

In one aspect, a first UE may transmit a priority order to a second UE. The priority order may be carried by SCI, PSSCH, MAC CE, or RRC. The priority order may be based at least in part on reducing power consumption, increasing reliability, and/or decreasing latency.

In one aspect, the second UE may determine coordination information (e.g., based on the priority order) and transmit the coordination information to the first UE. The first UE may receive the coordination information from the second UE. In one aspect, the coordination information may include an indicator carried by PSFCH or SCI. The indicator may include information associated with collision, power status, power saving mode, sensing, or resource allocation. The indicator may include information associated with collision, power status, power saving mode, sensing, or resource allocation. In an example, a resource collision may be determined based on a collision indicator.

In one aspect, the first UE may select a subset of types of resources (e.g., one or more of preferred, non-preferred, and resource conflict) from a type of resources set (e.g., preferred, non-preferred, and resource conflict) based on the received coordination information and/or based on a priority order. Selection of the subset of types of resources may be based based at least in part on one or more of a resource collision and/or one or more sensing operations. In some aspects, a PSSCH payload size may be determined based on SCI included in the coordination information and the subset of types of resources may be based at least in part on the PSSCH payload size.

In one aspect, the first UE may determine a resource association for a data transmission using the selected subset of types of resources. The first UE may transmit the data transmission using one or more resources in the determined resource allocation.

According to some aspects, different types of resource sets and signaling (e.g., preferred, non-preferred, resource conflict, etc.) may be considered and it may be indicated to UE which type of resources should be used based on certain criteria, e.g., least power consumption criteria. For example, different types of resource sets may be defined.

According to some aspects, methods and procedures for inter-UE coordination and determination for power saving may be provided. A UE may feedback a determination of which type of resource sets may have the most power saving. For example, UE A may communicate the types of resource sets to UE B via coordination information. UE B may determine which type of resource set may have the lowest power consumption in its sensing procedure. UE may perform sensing procedures for power saving accordingly.

As another example, UE B may feedback the desired type of resource set to UE A. UE B may request the desired type of resource set for power saving. UE A may refine its coordination information and send only the requested type of resource set. UE may receive priority order for power, reliability and latency. Moreover, different priorities may be assigned to power, reliability and latency, different priorities may be assigned to different resource types, and different priorities may be assigned to different resources of the same resource type. UE may determine the resource type and resource subset and perform sensing procedures on determined resource type and resource subset.

In one aspect, a 1-bit or 2-bit indicator may be used to indicate the collision, collision and collision status indication, power status indication, power saving mode indication, sensing and resource allocation type indication or the like.

In one aspect, PSFCH may be used for inter-UE coordination. In broadcast, a common PSFCH may be used to indicate resource collision when a collision occurs. In groupcast, a common PSFCH may be used to indicate resource collision when a collision occurs. In unicast, a dedicated PSFCH may be used to indicate resource collision when a collision occurs.

According to some aspects, efficient BWP operation and SL BWP adaptation may be used for power saving and power consumption reduction. For mode 1, BWP switching may use DCI, e.g., DCI format 3_0. A BWP indication field may be included in DCI format 3_0. According to some aspects, a new DCI format to support SL BWP in mode 1 may also be used. Mode 1 may use DCI to switch SL BWP at transmitting UE. Mode 1 may use SCI to enable SL BWP switching at receiving UE. A SL BWP indication field may be included in SCI for mode 1, e.g., SCI format 1-A, SCI format 2-A and SCI format 2-B. For mode 2 BWP switching may use SCI, e.g., SCI format 1-A, SCI format 2-A and SCI format 2-B. A BWP indication field may be included in SCI format. A BWP indication field may be included in SCI format 1-A, SCI format 2-A and SCI format 2-B. New SCI format to support SL BWP operation may also be used. In addition, for different cast types, e.g., unicast, groupcast and broadcast, BWP switching schemes may be designed and enabled for NR sidelink.

According to some aspects, to reduce UE power consumption and guarantee the data transmission rate, SL BWP may be used for NR SL. A SL BWP may be comprised of a number of continuous physical resource blocks (PRB) or resource pools with specific numerology. The SL BWP may be activated or de-activated by a timer, physical layer SCI signaling or higher layer RRC signaling. RRC, SCI, MAC CE and timer may be used for SL BWP activation, deactivation and switching. If configured SL BWP is one, then SL BWP indicator field is not present in SCI format. If configured SL BWP is more than one, then SL BWP indicator field is present in SCI format. SCI format may be SCI format 1-A. SCI format may be SCI format 2-A and 2-B. A new SCI format may also be used, such as SCI format 1-B, SCI format 1-X, SCI format 2-C, SCI format 2-Y or the like.

According to some aspects, SL preemption indicator (SL-PI) may be introduced to preempt non-URLLC traffic. When URLLC traffic arrives, the resources in time and frequency that are occupied by URLLC traffic may be indicated to the UEs. For example, scheduling UE may send a SL-PI to RX UEs indicating the resources in time and frequency that are occupied by URLLC traffic and may be preempted by RX UEs.

According to some aspects, to reduce power consumption, SL-PI may be monitored at the beginning of SL slot where SL control occurs. According to some aspects, SL-PI may be monitored within the SL slot where sub-slot SL control can be used. Resource or resource pool may be partitioned into several partitions. Such partitions may be indicated to SL UE using e.g., bit map. Each bit may correspond to each partition and if bit is set to “0”, then SL resource partition is not preempted. If bit is set to “1”, then SL resource partition is preempted. Different partition patterns may be used. Multiple partition patterns may be utilized. Partition pattern may be configurable. Different granularities for resource partition patterns may be used.

According to some aspects, SL cancellation indicator (SL-CI) may be used to cancel URLLC traffic. When URLLC traffic arrives, the resources in time and frequency that are occupied by URLLC traffic may be indicated to the UEs. For example, scheduling UE may send a SL-CI to TX UEs indicating the resources in time and frequency that are occupied by URLLC traffic and should be cancelled by TX UEs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

A more detailed understanding may be had from the following description, given by way of example in conjunction with accompanying drawings wherein:

FIG. 1 shows an example of enhanced power saving using inter-UE coordination method 1;

FIG. 2 shows an example of enhanced power saving using inter-UE coordination method 2;

FIG. 3 shows an example of enhanced power saving and reliability using inter-UE coordination;

FIG. 4 shows an example of enhanced BWP operation in NR Sidelink;

FIG. 5 shows an example method of SL-PI procedure;

FIG. 6 shows an example method of SL-PI procedure;

FIG. 7 shows an example method of configurable control field for SL-PI;

FIG. 8 shows an example method of configurable control field for SL-PI;

FIG. 9A illustrates an example communications system.

FIGS. 9B, 9C, and 9D are system diagrams of example RANs and core networks.

FIG. 9E illustrates another example communications system.

FIG. 9F is a block diagram of an example apparatus or device, such as a WTRU.

FIG. 9G is a block diagram of an exemplary computing system.

### DETAILED DESCRIPTION

Table 0.1 describes some of the abbreviations used herein.

TABLE 0.1
Abbreviations

| | |
|---|---|
| ACK | ACKnowledgement |
| BWP | Bandwidth Part |
| CC | Component Carrier |
| CCG | Component Carrier Group |
| CE | Control Element |
| CRC | Cyclic Redundancy Check |
| CSI | Channel State Information |
| DCI | Downlink Control Information |
| DMRS | DeModulation Reference Signal |
| DL | Downlink |
| HARQ | Hybrid Automatic Repeat Request |
| IE | Information Element |
| LTE | Long Term Evolution |
| MAC | Medium Access Control |
| MIB | Master Information Block |
| NACK | Non-ACKnowledgement |
| NR | New Radio |
| PIR | Packet Inter-Reception |
| PRB | Physical Resource Block |
| PRR | Packet Reception Ratio |
| PSBCH | Physical Sidelink broadcast Channel |
| PSCCH | Physical Sidelink Control Channel |
| PSFCH | Physical Sidelink Feedback Channel |
| PSSCH | Physical Sidelink Shared Channel |
| QoS | Quality of Service |
| RAN | Radio Access Network |
| RB | Resource Block |
| RBG | Resource Block Group |
| RNTI | Radio Network Temporary Identifier |
| RRC | Radio Resource Control |
| RSRP | Reference Signal Receive Power |
| RSU | Road Side Unit |
| S-SSB | Sidelink Synchronization Signal Block |
| S-RSRP | Sidelink Referenc Signal Receive Power |
| S-RSSI | Sidelink Received Signal Strength Indicator |
| SCI | Sidelink Control Information |
| SFI | Slot Format Indicator |
| SI | System Information |
| SINR | Signal to Interference and Noise Ratio |
| SL | Sidelink |
| SNR | Signal to Noise Ratio |
| TB | Transport Block |
| UE | User Equipment |
| UL | Uplink |
| V2V | Vehicle-to-Vehicle |
| V2X | Vehicle-to-everything |

Services and Requirements

NR V2X is designed with a broad set of advanced V2X use cases in mind and are broadly arranged into four use case groups: vehicular platooning, extended sensors, advanced driving, and remote driving.
(1) Vehicles Platooning enables the vehicles to dynamically form a platoon travelling together. All the vehicles in the platoon obtain information from the leading vehicle to manage this platoon. These information allow the vehicles to drive closer than normal in a coordinated manner, going to the same direction and travelling together.
(2) Extended Sensors enables the exchange of raw or processed data gathered through local sensors or live video images among vehicles, road site units, devices of pedestrian and V2X application servers. The vehicles can increase the perception of their environment beyond what their own sensors can detect and have a more broad and holistic view of the local situation. High data rate is one of the key characteristics.
(3) Advanced Driving enables semi-automated or full-automated driving. Each vehicle and/or RSU shares its own perception data obtained from its local sensors with vehicles in proximity and that allows vehicles to synchronize and coordinate their trajectories or maneuvers. Each vehicle shares its driving intention with vehicles in proximity too.
(4) Remote Driving enables a remote driver or a V2X application to operate a remote vehicle for those passengers who cannot drive by themselves or remote vehicles located in dangerous environments. For a case where variation is limited and routes are predictable, such as public transportation, driving based on cloud computing can be used. High reliability and low latency are main requirements.

According to some aspects, the most demanding requirements set may be for a maximum sidelink range of 1000 m, a maximum throughput of 1 Gbps, a shortest latency of 3 ms, a maximum reliability of 99.999%, and/or a maximum transmission rate of 100 messages/second. However, there is not a use case which, on its own, demands all of these bounding requirements. There are also requirements relating to security, integrity, authorization, and privacy.

NR V2X

NR V2X has physical layer support for broadcast, unicast, and groupcast sidelink operation. The addition of unicast and groupcast is linked with the introduction of sidelink HARQ feedback, high order modulation, sidelink CSI, and PC5-RRC, etc.

Physical sidelink channels and signals

The NR V2X sidelink uses the following physical channels and signals:
(1) Physical sidelink broadcast channel (PSBCH) and its DMRS;
(2) Physical sidelink control channel (PSCCH) and its DMRS;
(3) Physical sidelink shared channel (PSSCH) and its DMRS;
(4) Physical sidelink feedback channel (PSFCH);
(5) Sidelink primary and secondary synchronization signals (S-PSS and S-SSS) which are organized into the sidelink synchronization signal block (S-SSB) together with PSBCH. S-PSS and S-SSS can be referred to jointly as the sidelink synchronization signal (SLSS);
(6) Phase-tracking reference signal (PT-RS) in FR2; and
(7) Channel state information reference signal (CSI-RS).

NR-V2X sidelink supports subcarrier spacings of 15, 30, 60 and 120 kHz. Their associations to CPs and frequency ranges are similar to NR UL/DL, but use only the CP-OFDM waveform. The modulation schemes available are QPSK, 16-QAM, 64-QAM, and 256-QAM.

PSBCH transmits the SL-BCH transport channel, which carries the sidelink V2X Master Information Block (MIB-V2X) from the RRC layer. When in use, PSBCH transmits MIB-V2X every 160 ms in 11 RBs of the SL bandwidth, with possible repetitions in the period. DMRS associated with PSBCH are transmitted in every symbol of the S-SSB slot. S-PSS and S-SSS are transmitted together with PSBCH in the S-SSB. They jointly convey the SLSS ID used by the UE.

Sidelink control information (SCI) in NR V2X is transmitted in two stages. The first-stage SCI is carried on PSCCH and contains information to enable sensing operations, as well as information about the resource allocation of the PSSCH.

PSSCH transmits the second-stage SCI and the SL-SCH transport channel. The second-stage SCI carries information needed to identify and decode the associated SL-SCH, as well as control for HARQ procedures, and triggers for CSI feedback, etc. SL-SCH carries the TB of data for transmission over SL.

The resources in which PSSCH is transmitted can be scheduled or configured by a gNB or determined through a sensing procedure conducted autonomously by the transmitting UE. A given TB can be transmitted multiple times. DMRS associated with rank-1 or rank-2 PSSCH can be transmitted in 2, 3, or 4 sidelink symbols distributed through a sidelink slot. Multiplexing between PSCCH and PSSCH is in time and frequency within a slot.

PSFCH carries HARQ feedback over the sidelink from a UE which is an intended recipient of a PSSCH transmission (henceforth an Rx UE) to the UE which performed the transmission (henceforth a Tx UE). Sidelink HARQ feedback may be in the form of conventional ACK/NACK, or NACK-only with nothing transmitted in case of successful decoding. PSFCH transmits a Zadoff-Chu sequence in one PRB repeated over two OFDM symbols, the first of which can be used for AGC, near the end of the sidelink resource in a slot. The time resources for PSFCH are (pre-)configured to occur once in every 1, 2, or 4 slots.

Resource Allocation Modes

Mode 1

Mode 1 is for resource allocation by gNB. The use cases intended for NR V2X may generate a diverse array of periodic and aperiodic message types. Therefore, resource allocation mode 1 may provide dynamic grants of sidelink resources from a gNB, as well as grants of periodic sidelink resources configured semi-statically by RRC.

A dynamic sidelink grant DCI may provide resources for one or multiple transmissions of a transport block, in order to allow control of reliability. The transmission(s) may be subject to the sidelink HARQ procedure, if that operation is enabled.

A sidelink configured grant may be such that it is configured once and may be used by the UE immediately, until it is released by RRC signalling (known as Type 1). A UE may be allowed to continue using this type of sidelink configured grant when beam failure or physical layer problems occur in NR Uu until an RLF detection timer expires, e.g., before falling back to an exception resource pool. The other type of sidelink configured grant, known as Type 2, may be configured once but cannot be used until the gNB sends the UE a DCI indicating it is now active, and only until another DCI indicates de-activation. The resources in both types are a set of sidelink resources recurring with a periodicity which a gNB will desire to match to the characteristics of the V2X traffic. Multiple configured grants may be configured, to allow provision for different services, traffic types, etc.

MCS information for dynamic and configured grants may optionally be provided or constrained by RRC signaling, e.g., instead of the traditional DCI. RRC may configure the exact MCS the Tx UE uses, or a range of MCS. It may also be left unconfigured. For the cases where RRC does not provide the exact MCS, the transmitting UE may be left to select an appropriate MCS itself based on the knowledge it has of the TB to be transmitted and, potentially, the sidelink radio conditions.

Mode 2

Mode 2 is for UE autonomous resource selection. Its basic structure is of a UE sensing within a (pre-)configured resource pool of resources not in use by other UEs with higher-priority traffic and choosing an appropriate amount of such resources for its own transmissions. Having selected such resources, the UE can transmit and re-transmit in them a certain number of times, or until a cause of resource reselection is triggered.

The mode 2 sensing procedure may select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. According to some aspects, it may select resources to be used for the initial transmission of a later transport block, in which case the resources are indicated in an SCI scheduling a current transport block. Finally, an initial transmission of a transport block may be performed after sensing and resource selection, but without a reservation.

The first-stage SCIs transmitted by UEs on PSCCH may indicate the time-frequency resources in which the UE will transmit a PSSCH. These SCI transmissions may be used by sensing UEs to maintain a record of which resources have been reserved by other UEs in the recent past.

The sensing UE may then select resources for its (re-)transmission(s) from within a resource selection window. The window starts shortly after the trigger for (re-)selection of resources and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

BWP

BWPs are defined for the sidelink in a similar way as for UL/DL, to provide a convenient way to specify aspects relating to a UEs RF hardware chain implementation. A UE is configured with one active sidelink BWP when in connected mode to a gNB, which is the same as the single sidelink BWP used for idle mode or out-of-coverage operation.

The subcarrier spacing used on sidelink is provided in the sidelink BWP (pre-)configuration, from the same set of values and associations to frequency ranges as for the Uu interface (i.e. 15, 30, or 60 kHz for FR1; and 60 or 120 kHz for FR2). Sidelink transmission and reception for a UE are thus contained within a sidelink BWP, and the same sidelink BWP is used for both transmitting and receiving. This means that resource pools, S-SSB, etc. must also be contained within an appropriate sidelink BWP from the UE's perspective.

### Problem Statement

Problem (Enhanced Sensing with Inter-UE Coordination)

In Rel-16, basic sidelink communications have been supported. In current NR SL system, sensing and resource (re-)selection are based on an assumption that no coordination signaling is available. In Rel-17, enhancement to reliability and latency is needed. In addition, power consumption reduction is also required. Inter-UE coordination is introduced to enhance the performance for reliability and latency. In case of coordination, coordination information may be utilized to enhance sensing procedure and/or resource (re-)selection procedures. Inter-UE coordination may also be considered to enable power saving and power consumption reduction. Methods and solutions using inter-UE coordination scheme for enabling power saving as well as enhancing reliability and reducing latency are required.

Problem (SL BWP Operations)

In Rel-16, BWP has been supported for Uu interface to enable power saving and link adaptation, as well as to support UEs with different bandwidths. Basic BWP operation for NR sidelink communications have also been supported in which only one BWP may be configured and active for SL. To benefit from power saving due to bandwidth adaptation for SL, advanced BWP operations should be considered in NR SL. Methods and solutions for efficient BWP operation in SL are required.

Problem (Low Latency and Reduced Power Operation in SL)

Current priority-based preemption in SL is not efficient to handle URLLC traffic in SL since all PSSCH may not be able to transmit for a UE if its priority is low. Current priority-based preemption in SL is not efficient to handle URLLC traffic in SL since a transmission of a non-URLLC SL traffic over a PSSCH to a peer UE may not be possible or an ongoing transmission of a non-URLLC SL traffic over PSSCH might not be able to complete if the non-URLLC SL traffic is of a lower priority than that of the SL URLLC traffic. Additionally, if URLLC is monitored frequently, power consumption could be high. Methods and solutions to reduce power consumption and enable power saving are required.

### Proposed Solutions

Solution for Enhanced Sensing with Inter-UE Coordination

One solution may be to consider different types of resource sets and signaling (e.g., preferred, non-preferred, resource conflict, etc) and indicate to UE which type of resources should be used based on certain criteria (e.g., least power consumption criteria). Different types of resource sets may be defined.

According to some aspects, methods and procedures for inter-UE coordination and determination for power saving are provided. UE may feedback the determination of which type of resource sets may have the most power saving. For example, UE A may include the types of resource sets to UE B via coordination information. UE B may determine which type of resource set may have the lowest power consumption in its sensing procedure. UE may perform sensing procedures for power saving accordingly.

In another solution, UE B may feedback the desired type of resource set to UE A. UE B may request the desired type of resource set for power saving. UE A may refine its coordination information and send only the requested type of resource set. This may reduce overhead of coordination information or assistance information from UE A and at the same time reduce the power consumption for the sensing operation at UE B. A UE may receive priority order for power, reliability and latency. Moreover, different priorities may be assigned to power, reliability and latency, different priorities may be assigned to different resource types, and different priorities may be assigned to different resources of the same resource type. UE may determine the resource type and resource subset and perform sensing procedures on determined resource type and resource subset. Priorities information may be carried by SCI, e.g., the first-stage SCI. Priorities information may also be carried by PSSCH, MAC CE, RRC or the like.

A 1-bit or 2-bit indicator may be used to indicate the collision, collision and collision status indication, power status indication, power saving mode indication, sensing and resource allocation type indication or the like. The indicator may be carried in PSFCH. The indicator may be carried in SCI e.g., the first-stage SCI or 2nd stage SCI. Priorities information may also be carried by PSSCH, MAC CE, RRC or the like.

PSFCH may be used for inter-UE coordination. In broadcast, a common PSFCH may be used to indicate resource collision when a collision occurs. In groupcast, a common PSFCH may be used to indicate resource collision when a collision occurs. In unicast, a dedicated PSFCH may be used to indicate resource collision when a collision occurs.

Solution for SL BWP Operations

Efficient BWP operation and SL BWP adaptation may be used for power saving and power consumption reduction. For mode 1, BWP switching may use DCI, e.g., DCI format 3_0. A BWP indication field may be included in DCI format 3_0. According to some aspects, a new DCI format to support SL BWP in mode 1 may also be used. Mode 1 may use DCI to switch SL BWP at transmitting UE. Mode 1 may use SCI to enable SL BWP switching at receiving UE. An SL BWP indication field may be included in SCI for mode 1, e.g., SCI format 1-A, SCI format 2-A and SCI format 2-B. For mode 2 BWP switching may use SCI, e.g., SCI format 1-A, SCI format 2-A and SCI format 2-B. A BWP indication field may be included in SCI format. A BWP indication field may be included in SCI format 1-A, SCI format 2-A and SCI format 2-B. New SCI format to support SL BWP operation may also be used. In addition, for different cast types (e.g., unicast, groupcast and broadcast), BWP switching schemes may be designed and enabled for NR sidelink.

To reduce UE power consumption and guarantee the data transmission rate, SL BWP may be used for NR SL. An SL BWP may comprise a number of contiguous physical resource blocks (PRB) or resource pools with specific numerology. The SL BWP may be activated or de-activated by a timer, physical layer SCI signaling or higher layer RRC signaling, or implicitly based on the sidelink communication cast types, for example unicast, groupcast and broadcast. An establishment or release of an SL communication cast type may trigger the activation, deactivation, or switching of a SL BWP. RRC, SCI, MAC CE and timer may be used for SL BWP activation, deactivation and switching. For example, if configured SL BWP is one, then SL BWP indicator field is not present in SCI format. Moreover, if configured SL BWP is more than one, then SL BWP indicator field is present in SCI format. SCI format may be SCI format 1-A. SCI format may be SCI format 2-A and 2-B. A new SCI format may also be used, such as SCI format 1-B, SCI format 1-X, SCI format 2-C, SCI format 2-Y or the like.

Solution for Low Latency and Reduced Power Operation in SL

SL preemption indicator (SL-PI) may be introduced to preempt non-URLLC traffic. When URLLC traffic arrives, the resources in time and frequency that are occupied by URLLC traffic may be indicated to the UEs. For example, scheduling UE may send an SL-PI to RX UEs indicating the resources in time and frequency that are occupied by URLLC traffic and should be preempted by RX UEs.

To reduce power consumption, SL-PI may be monitored at the beginning of an SL slot where SL control occurs. According to some aspects, SL-PI may be monitored within the SL slot where sub-slot SL control can be used. A resource or resource pool may be partitioned into several partitions. Such partitions may be indicated to SL UE using, e.g., bit map. Each bit may correspond to each partition and if bit is set to “0”, then SL resource partition is not preempted. If bit is set to “1”, then SL resource partition is preempted. According to some aspects, different partition patterns may be used. According to some aspects, multiple partition patterns may be utilized. According to some aspects, partition pattern may be configurable. According to some aspects, different granularities for resource partition patterns may be used.

According to some aspects, power consumption may be reduced by using SL cancellation indicator (SL-CI) to cancel non-URLLC traffic. When URLLC traffic arrives, the resources in time and frequency that are occupied by URLLC traffic may be indicated to the UEs. For example, a scheduling UE may send a SL-CI to TX UEs indicating the resources in time and frequency that are occupied by URLLC traffic and should be cancelled by TX UEs for non-URLLC traffic.

According to another aspect, power consumption may be reduced by introducing SL preemption indicator (SL-PI) to preempt URLLC traffic. The preemption indicator may take the form of a binary indicator or enumerated for, e.g., pre-empted or not pre-empt. In another embodiment, the preemption indicator may be associated with a threshold, e.g., threshold-1 configured into the UE. The receiving UE of a preemption indication may compare the preemption indication value to threshold-1 and determine whether or not to pre-empt the traffic, e.g., URLLC traffic associated with the SL pre-emption indicator. For example, in one aspect, if the preemption indicator value is lower than threahold-1, the URLLC traffic is pre-empted. In another aspect, the UE behavior may be specified if the preemption indicator value is higher than threshold-1, e.g., the URLLC traffic is pre-empted. In another embodiment, a threshold may be defined to control which traffic is preemptable and which traffic is not preemptable, e.g., threshold-2. For example, any URLLC traffic associated with a preemption value below threshold-2 is not preemptable. In another embodiment, any traffic associated with a preemption value above threshold-2, is not preemptable. In yet another embodiment, once a traffic is determined to be preemptable, a relative compassion using threahold-1 may be used to determine whether a URLLC SL traffic should be preempted by another traffic (URLLC or non-URLLC) as per the above embodiments that described the use of threshold-1. Additionally, a SL priority indicator may be introduced for admission control of sidelink traffic, e.g., URLLC traffic. A controlling UE or scheduling UE may decide to admit a traffic such as URLLC traffic or deny admission of a URLLC traffic based on the priority value of the traffic. For example, a priority threshold-3 may be configured into the controlling or scheduling UE. If the priority of the traffic is below threshold-3, the traffic is admitted. In some aspects, if the priority of the traffic is above threshold-3, the traffic is admitted.

Enhanced Sensing with Inter-UE Coordination

One solution may be to consider different types of resource set and signaling (e.g., preferred, non-preferred, resource conflict, etc.) and indicate from one UE to another UE which type of resources should be used based on certain criteria (e.g., least power consumption criteria). According to some aspects, different types of resource sets may be defined. For example, Type A resource set may be defined as the type or resource wherein UE-A may send to UE-B the set of resources preferred for UE-B's transmission, e.g., based on its sensing result. Type B resource set may be defined as the type or resource wherein UE-A may send to UE-B the set of resources not preferred for UE-B's transmission, e.g., based on its sensing result and/or expected and/or potential resource conflict. Type C resource set may be defined as the type of resource wherein UE-A may send to UE-B the set of resources where the resource conflict is detected. Methods and procedures for determining the type of resource for power saving may be considered.

Different types of resources or resource sets may result in different sizes of resources for sensing at transmitting UE. For example, the larger the resource size for sensing in sensing procedures, the more power the UE may consume. Methods and procedures for inter-UE coordination and determination for power saving may be used. The decision to choose resource set type A, B or C or any combination of them may be based on power consumption (e.g., high or low power consumption), traffic type (e.g., periodic or aperiodic traffic), latency, overhead and the like. The granularity of the coordination, in terms of Type A, Type B or Type C resource, may be in unit of BWP, resource pool, subchannel, PRB, or resource element level. A coarse granularity at the BWP level may be linked to the SL BWP operation.

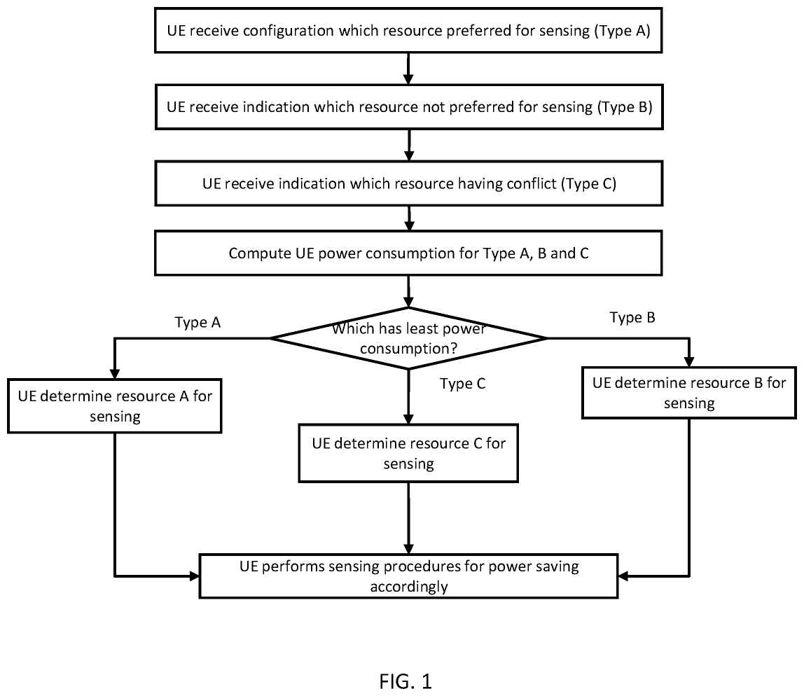

According to some aspects, enhanced power saving using inter-UE coordination is depicted in FIG. 1. UE may receive indication for which resources may be preferred for use (e.g., resource type A). UE may receive indication for which resources may not be preferred for use (e.g., resource type B). UE may also receive indication for which resources may have resource conflict (e.g., resource type C). UE may determine power consumption for resource types A, B and C and determine which resource type may have the least power consumption or most power saving. For example, if resource type A has the least power consumption, UE may determine the resource type A to use for sensing. As another example, if resource type B has the least power consumption, UE may determine the resource type B to use for sensing. Otherwise, if resource type C has the least power consumption, then UE may determine the resource type C to use for sensing. UE may feedback the determination which type of resource sets may have the most power saving. For example, UE A may include the types of resource sets to UE B via coordination information. UE B may determine which type of resource set may have the lowest power consumption in its sensing procedure. UE may perform sensing procedures for power saving accordingly.

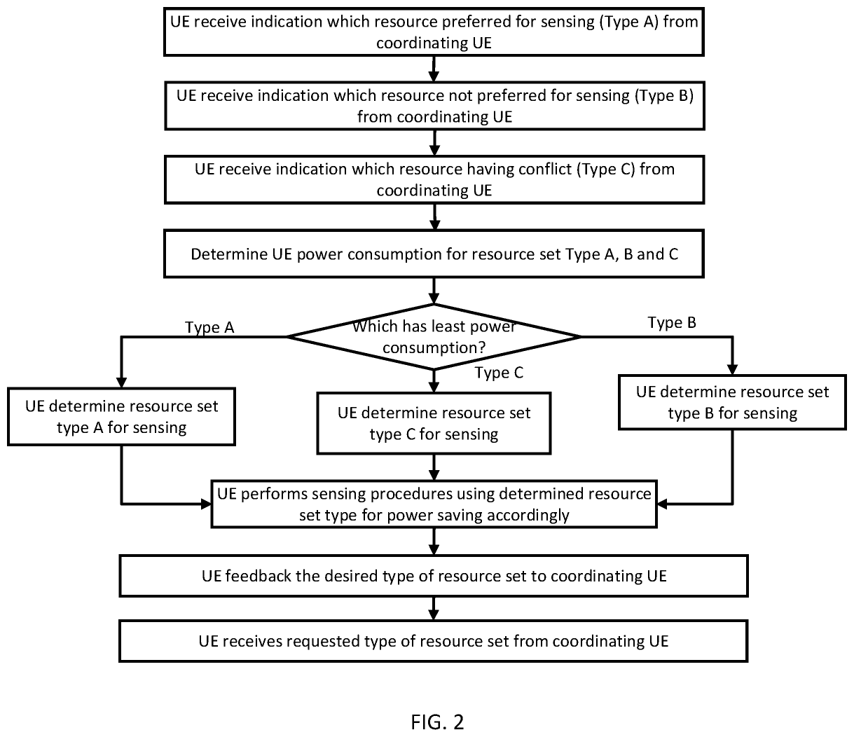

According to some aspects, as shown in FIG. 2, UE B may feedback the desired type of resource set to UE A. UE B may request the desired type of resource set for power saving. UE A may refine its coordination information and send only the requested type of resource set. This may reduce overhead of coordination information or assistance information from UE A and at the same time reduce the power consumption for the sensing operation at UE B.

The resource or resource set may be determined based on power saving, reliability and latency. The priority may be assigned to and associated with power saving, reliability and latency. Different priorities may be assigned to different resource types and different priorities may be assigned to different resources of the same resource type. The highest priority may be used as criteria first for decision making. The lower priority may be used as criteria later for decision making.

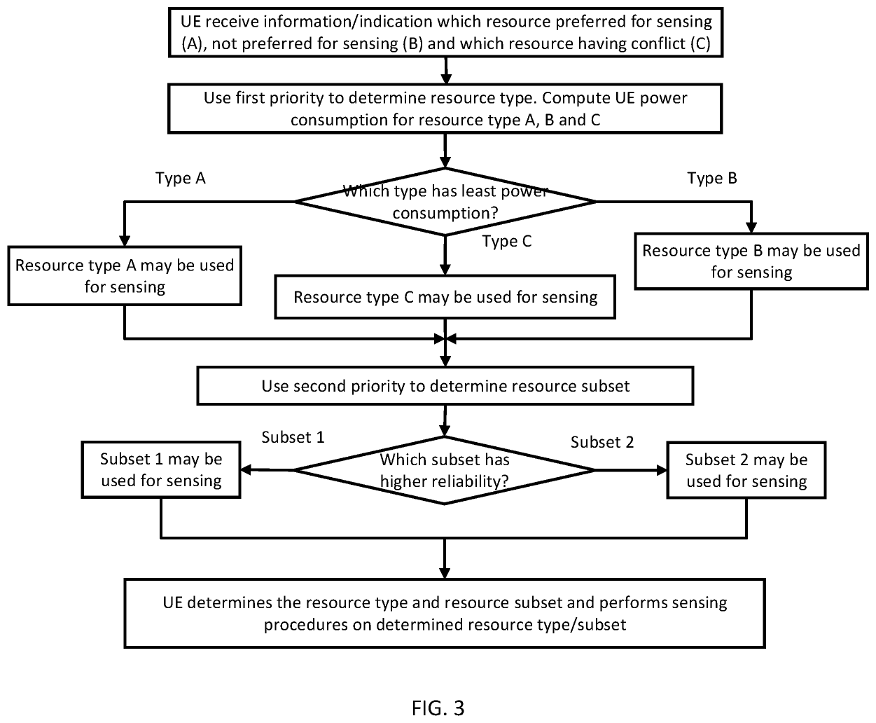

According to some aspects, enhanced power saving considering power and reliability using inter-UE coordination is depicted in FIG. 3.

UE may receive priority order for power, reliability and latency. Moreover, different priorities may be assigned to power, reliability and latency, different priorities may be assigned to different resource types, and different priorities may be assigned to different resources of the same resource type. For example, higher priority may be assigned to power saving. Lower priority may be assigned to reliability. UE may first determine a proper resource type based on power saving requirement. After that, UE may further determine the resource subset based on reliability.

UE may receive information/indication for which resource or resource set may be preferred for sensing (e.g., type A), which resource or resource set may not be preferred for sensing (e.g., type B), and which resource or resource set may have resource conflict (e.g., type C). UE may determine UE power consumption for resource types A, B and C. UE may determine the resource type for sensing.

For the determined resource type, UE may further determine which subset of resources may have the highest reliability. If resource subset 1 has higher reliability, then UE may determine to use resource subset 1 for sensing. If resource subset 2 has higher reliability, then UE may determine to use resource subset 2 for sensing.

UE may determine the resource type and resource subset and perform sensing procedures on determined resource type and resource subset accordingly.

According to some aspects, UE may consider power saving, reliability and latency. UE may receive priority order for power saving, reliability and latency. The first priority or high priority may be assigned to power saving, the second priority or medium priority may be assigned to latency, and the third priority or low priority may be assigned to reliability. UE may determine resource based on priority order. UE may first determine a proper resource type based on power saving criteria. After that, UE may further determine the resource subset based on latency and determine the resource subset based on reliability.

Criteria and associated priority may be communicated from coordinating UE to coordinated UE. A coordinating UE may be the UE which may provide coordination information or assistance information to other UE or UEs. A coordinated UE may be the UE which may receive coordination information or assistance information from coordinating UE to help its own transmission. A subset of criteria and associated priority may be communicated from coordinating UE to coordinated UE. The parameters for sensing and resource selection and reselection may be exchanged between two UEs and among multiple UEs. The power saving parameters for sensing and resource (re-)selection may be communicated to/from each other and may exchange between and among UEs. Coordination by sending parameters for sensing, resource selection and reselection, for contiguous and periodic-based partial sensing may be utilized.

Another solution may be that the coordinating UE may perform sensing and schedule the resources for coordinated UE(s) for transmission without sensing to enable power saving for coordinated UE(s).

PSFCH may be used for inter-UE coordination. In broadcast, a common PSFCH may be used to indicate resource collision when a collision occurs. In groupcast, a common PSFCH may be used to indicate resource collision when a collision occurs. In unicast, a dedicated PSFCH may be used to indicate resource collision when a collision occurs.

PSCCH may be used for inter-UE coordination. SCI may be used for inter-UE coordination. For example, the legacy first-stage SCI or second-stage SCI may be enhanced in support of the enhanced power saving, reliability or latency driven inter-UE coordination sensing based resource allocation schemes described herein. PSSCH, MAC CE, MAC CE carried in PSSCH, MAC CE multiplexed in PSSCH or the like may be used for inter-UE coordination.

Whether and which of PSFCH, SCI, PSCCH, PSSCH, MAC CE or RRC to use for inter-UE coordination may depend on condition(s), payload size, cast type or the like. For example, PSFCH may be used for or associated with groupcast or broadcast, and PSCCH, PSSCH or MAC CE may be used for or associated with unicast for inter-UE coordination.

For example, PSCCH and/or MAC CE may be used to carry an inter-UE coordination request or inter-UE coordination information when a payload size of an inter-UE coordination request or inter-UE coordination information is small (e.g., less than a predetermined threshold). MAC CE may be used to carry an inter-UE coordination request or inter-UE coordination information when a payload size of an inter-UE coordination request or inter-UE coordination information is large (e.g., larger than a predetermined threshold).

As another example, SCI (e.g., second stage SCI) and/or MAC CE may be used to carry an inter-UE coordination request or inter-UE coordination information when a payload size of an inter-UE coordination request or inter-UE coordination information is small (e.g., less than a predetermined threshold). MAC CE may be used to carry an inter-UE coordination request or inter-UE coordination information when the payload size of an inter-UE coordination request or inter-UE coordination information is large (e.g., larger than a predetermined threshold). Other combinations may also be possible and inter-UE coordination may be further configurable. Moreover, a channel to use for inter-UE coordination may be dynamically selected, indicated or activated, or semi-statically configured.

A 1-bit or 2-bit indicator may be used to indicate the collision. According to some aspects, an example of indicator for collision indication is depicted in Table 1.

TABLE 1
Indicator for collision

| Collision | |
|---|---|
| Indicator | Collision Status |
| “1” | Collision occurs |
| “0” | Collision does not occur |

According to some aspects, another example of indicator for collision and collision status indication is depicted in Table 2.

TABLE 2
Indicator for collision and collision status

| Collision | |
|---|---|
| Indicator | Collision Status |
| “11” | Collision occurs with high probability |
| “10” | Collision occurs with low probability |
| “01” | Collision does not occur |
| “00” | reserved |

According to some aspects, an example of indicator for collision and collision type indication is depicted in Table 3. Collision may be pre-collision or post-collision. Pre-collision may be expected or potential collision that does not happen yet but may happen in near future. Post-detection may be the collision that already happened and collision may already be detected.

TABLE 3
Indicator for collision and collision type

| Collision | Collision Type | |
|---|---|---|
| Indicator | indicator | Collision Status |
| “1” | Pre-collision | Collision occurs and it is pre-collision |
| “1” | Post-collision | Collision occurs and it is post-collision |
| “0” | NA | Collision does not occur |
| “0” | reserved | reserved |

PSFCH may be used to indicate power status. For example, PSFCH may be used to indicate power level or battery status. PSCCH may be used to indicate power status. SCI may be used to indicate power status. PSSCH and MAC CE may be used to indicate power status.

SCI, PSFCH, PSCCH, PSSCH, MAC CE may be used to convey power saving parameter or information for enabling power saving. A 1-bit or 2-bit indicator may be used to indicate the power status. According to some aspects, an example of power indication is depicted in Table 4.

TABLE 4
Indicator for power

| Power | |
|---|---|
| Indicator | Power Status |
| “1” | Power is high |
| “0” | Power is low |

Power may refer to consumed power, power consumption level, remaining power, battery status or the like. According to some aspects, another example of power saving mode indication is depicted in Table 5.

TABLE 5
Indicator for power saving mode

| Power mode | |
|---|---|
| Indicator | Power mode Status |
| “1” | Power saving mode |
| “0” | Non-power saving mode |

According to some aspects, another example of indicator for sensing and resource allocation type indication is depicted in Table 6.

TABLE 6
Indicator for sensing and resource allocation type

| Sensing and resource | |
|---|---|
| allocation type Indicator | Sensing and resource allocation type |
| “11” | Reserved |
| “10” | Random resource selection |
| “01” | Partial sensing |
| “00” | Full sensing |

According to some aspects, another example of indicator for sensing and resource allocation type indication is depicted in Table 7.

TABLE 7
Indicator for sensing and resource allocation type

| sensing and resource | |
|---|---|
| allocation type Indicator | sensing and resource allocation type |
| “11” | Random resource selection |
| “10” | Contiguous partial sensing |
| “01” | Periodic-based partial sensing |
| “00” | Full sensing |

According to some aspects, inter-UE coordination based random resource selection and partial sensing may be used to further reduce power consumption and enable power saving. UE may have sidelink reception capability. Assistance information may be provided to UE for performing random resource selection and/or partial sensing. Power saving mode, non-power saving mode or power saving UE may be indicated or configured by the group leader or manager, another UE, RSU, gNB or network. Multiple resource pools may be configured or pre-configured to power saving UEs. Group leader or manager, another UE or RSU may indicate to the UE which resource pool may be used for random resource selection and which resource pool may be used for partial sensing. The indicated resource pool may be based on certain measurements and criteria, e.g., CBR measurement. For example, if measured CBR is below a CBR threshold, then random resource selection may be used. Otherwise, partial sensing may be used. Multi-thresholds for CBR may be used.

According to some aspects, if measured CBR is below a first CBR threshold, then random resource selection may be used. If measured CBR is below a second CBR threshold, then partial sensing may be used. Otherwise, full sensing may be used. A first CBR threshold may be lower than a second CBR threshold. Indication may be communicated to the UE via SCI, e.g., via the 1st stage SCI, the 2nd stage SCI, PSSCH, and/or MAC CE. A UE may indicate the indication or measurement(s) (e.g., CBR) via unicast, groupcast or broadcast. Other measurements may include channel occupancy ratio (CR), SL-RSRP, SL-RSSI, or the like.

According to some aspects, inter-UE coordination based periodic partial sensing may be used. Parameters related to periodic-based partial sensing may be communicated to the UE(s). Parameters related to periodic-based partial sensing may include the periodicity of reservation, P_reserve, PSCCH monitoring occasion, k, timer or the like. Inter-UE coordination based contiguous partial sensing may be used. Parameters related to contiguous partial sensing may be communicated to the UE(s). Parameters related to contiguous partial sensing may include the periodicity of reservation, P_reserve, PSCCH monitoring occasion, k, timer, contiguous sensing window, starting point of contiguous sensing window, ending point of contiguous sensing window, contiguous sensing window size or the like.

If sensing results are inadequate, UE may use assistance information to obtain the required sensing information for reliable resource selection. For example, if the sensing samples are not enough or sensing window is not large enough, the sensing may be inadequate and the sensing results may not be sufficiently accurate or may not be accurate at all. Assistance information may provide a set of resources that power saving UEs may use for increased reliability in their resource selection procedure.

According to some aspects, power saving UEs may be required to be active based on their location. For example, UEs may wake up and transmit only when they are in a pre-configured zone, region or location. SCI may indicate destination ID. Power saving UEs may not perform unnecessary decoding. For example, the reserved bits in SCI format 1-A may be used to indicate the destination ID. Power saving UEs may not decode the transmissions that are not meant for the UE. SL DRX may reduce sensing time a UE has to determine resources for its transmissions. UE may not perform sensing during SL DRX inactive period and may use the sensing results obtained from the assistance information using inter-UE coordination. Inter-UE coordination may be carried out by another UE(s), RSUs, leader of group UEs, or the like to provide a set of resources to power saving UEs. UEs may combine their limited sensing results with assistance information received to determine the best available resources for their transmissions. According to some aspects, this may be advantageous when UEs are restricted to only limited sensing results due to SL DRX configurations.

According to some aspects, the assistance information may be triggered by request proactively. UEs at low power level or power saving mode may reduce or skip the sensing and/or resource selection process to enable power saving. UEs may require power consumption to be minimized. The UEs may be actively transmitting and receiving only when in an indicated location or zone. For example, pedestrian UEs may be required to be active when they are close to roads and intersections and may be inactive when they are indoors. Public safety UEs may need to be active only when at emergency locations and may be inactive otherwise. Power saving UE's activity may be restricted based on the zone and/or location.

According to some aspects, by defining pre-configured locations or zones, the UEs may wake up, transmit or receive only when they are in the indicated zone or location. SL DRX may enable UE to wake up in these zones, regions or locations. Assistance information and SL DRX may be combined or jointly used to minimize power consumption and maximize the power saving. Location-based or zone-based activation and de-activation for power saving UEs may ensure better power saving. The 1st stage SCI may be used by UEs to obtain sensing results, and the second stage SCI may include relevant information for UEs to decode the transmission. The intended receiver's destination ID may be included in the second stage SCI. The reserved bits in SCI format 1-A may be used to include the destination ID or a part of the destination ID. This may provide the receiver UE whether it is the intended receiver or not. UE may discard and avoid decoding the 2nd stage SCI and PSSCH to achieve better power saving. It may combine with the other power saving techniques to achieve further power consumption reduction.

Inter-UE communication among partial sensing UEs may be used. The UE may indicate the partial sensing time intervals to other UE when the other UE monitors the PSCCH or perform partial sensing. Partial sensing time intervals may be determined by traffic type or packet pattern. Partial sensing time intervals or PSCCH monitoring intervals may be a function of UE source ID and/or destination ID. For example, L2 destination ID, L1 destination ID, L2 source ID and/or L1 source ID may be used. The time intervals and related parameters may be exchanged or indicated to each other.

According to some aspects, UE may perform periodic-based partial sensing, contiguous partial sensing, joint periodic-based partial sensing and contiguous partial sensing or combination of periodic-based partial sensing and contiguous partial sensing. UE may indicate the type of sensing to other UE and indicate type of traffic to other UE. For periodic traffic, periodic-based partial sensing may be used. For aperiodic traffic, contiguous partial sensing may be used. If traffic type is unknown or not certain, joint or combination of periodic-based partial sensing and contiguous partial sensing may be used.

According to some aspects, resource re-evaluation and pre-emption may be used for random resource selection. Partial sensing may be used for resource re-evaluation and pre-emption. Contiguous partial sensing may be used for resource re-evaluation and pre-emption. Periodic-based partial sensing may be used for resource re-evaluation and pre-emption. Partial sensing, contiguous partial sensing and/or periodic-based partial sensing for resource re-evaluation and pre-emption may be performed between time of resource selection and resource re-evaluation/pre-emption checking. Different or separate SL-RSRP thresholds may be used for partial sensing and full sensing. Different or separate SL-RSRP thresholds may be used for contiguous partial sensing and periodic-based partial sensing.

According to some aspects, the sidelink DRX on duration and UE's configured sensing intervals or sensing periods may be aligned. According to some aspects, the overlapping of sidelink DRX on duration and UE's configured sensing intervals or sensing periods may be maximized. Transmitting UE may avoid sidelink transmission resources allocation during the receiving UE's DRX off duration. Sensing parameters may be communicated between UEs or indicated to each other. DRX parameters may be communicated between UEs or indicated to each other. This may be done via inter-UE coordination via message and/or signaling exchange.

According to some aspects, DRX patterns of different UEs on a resource pool may be either non-overlapping or fully overlapping. Inactivity timer for different cast types may be used which may result in partial overlap of different DRX patterns. To mitigate the collision, restrictions on scheduling a transmission outside of a receiving UE's DRX ON duration may be imposed. For example, the TBs with priority higher than a threshold or priority value lower than a threshold may be scheduled in DRX OFF duration or outside of the DRX ON duration.

According to some aspects, DRX may be configured per resource pool. Some resources or resource pools may be configured with DRX and other resources or resource pools may be configured without DRX. For the same resource or resource pool, DRX patterns of different UEs on a resource pool may be either non-overlapping or fully overlapping. For different resources or resource pools, DRX patterns of different UEs may be partial overlapping. UE may inform the group leader or another UE of its preference on sensing parameters and/or DRX parameters for power saving. The UE may include the sensing and/or resource allocation timing or the like in coordination information or assistance information to inform the group leader, another UE or RSU for enabling better coordination and power saving in SL.

According to some aspects, resources, resource types, and/or resource pools may be associated with different priorities. Different priority thresholds may be configured for different resources or resource pools. Different priorities may be associated with or configured for different types of sensing and resource selection schemes. Depending on type of sensing and resource selection scheme, different resources or resource pools may be used. For example, random resource selection may be associated with high priority. Thus, random resource selection may select the resources or resource pools with high priority for transmission. Type of sensing and resource allocation schemes may be full sensing, contiguous partial sensing, periodic-based partial sensing, random resource selection with re-evaluation and pre-emption and random resource selection without re-evaluation and pre-emption. Partial sensing may be performed in frequency domain (e.g., in terms of PRBs) in addition to time domain (e.g., in terms of timeslot). When UE has a TB to transmit, it may assign a priority to TB and indicate priority in SCI. When priority is higher than priority associated with the resources or resource pools, then the corresponding resources or resource pools may be selected and used for transmission. For high priority sensing scheme, TB may be high or low priority. Similarly, for low priority sensing scheme, TB may be high or low priority.

According to some aspects, PSFCH period may be enlarged to reduce the power consumption caused by PSFCH transmission. PSFCH period may be indicated in SCI, MAC CE or RRC. UE battery status, battery level, power consumption status and/or power level may be indicated to gNB or network. gNB or network may be used to adjust PSFCH period based on UE battery status, battery level, power consumption status and/or power level. For example, if UE power level or battery level is higher than a threshold, then PSFCH period may be increased. Otherwise, PSFCH period may not be increased or decreased.

According to some aspects, Pᵣₑₛₑᵣᵥₑ may be the periodicity of reservation. Configuring Pᵣₑₛₑᵣᵥₑ with all reservation periodicities may lead to higher power consumption. Configuring Pᵣₑₛₑᵣᵥₑ with subset of the reservation periodicities used by other UEs may cause higher resource collisions. Inter-UE coordination may be used to optimize the reservation periodicity for UEs. UEs may communicate the collision status including pre-detection collision, post-detection collision or both) to other UEs. UE may determine the reservation periodicities based on collision status. For example, if collision status indicates “high”, then more or all reservation periodicities may be used. If collision status indicates “low”, then less or subset of reservation periodicities may be used. UE may switch back to full sensing from random resource selection or partial sensing based on timer or counter. UE may switch back to partial sensing from random resource selection based on timer or counter. UE may switch back to non-power saving mode from power saving mode based on timer or counter.

SL BWP Operations

According to some aspects, efficient BWP operation and SL BWP adaptation may be used for power saving and power consumption reduction. For mode 1, BWP switching may use DCI, e.g., DCI format 3_0. A BWP indication field may be included in DCI format 3_0. According to some aspects, anew DCI format to support SL BWP in mode 1 may also be used. Mode 1 may use DCI to switch SL BWP at transmitting UE. Mode 1 may use SCI to enable SL BWP switching at receiving UE. An SL BWP indication field may be included in SCI for mode 1, e.g., SCI format 1-A, SCI format 2-A and SCI format 2-B. For mode 2 BWP switching may use SCI, e.g., SCI format 1-A, SCI format 2-A and SCI format 2-B. A BWP indication field may be included in SCI format. A BWP indication field may be included in SCI format 1-A, SCI format 2-A and SCI format 2-B. New SCI format to support SL BWP operation may also be used. In addition, for different cast types (e.g., unicast, groupcast and broadcast), BWP switching schemes may be designed and enabled for NR sidelink. Configuration, operation, activation and deactivation for BWP(s)/resource pools and switch BWP(s)/resource pools efficiently in NR sidelink are proposed. Resource pools and BWP may be used either jointly or individually. They may also be used interchangeably.

According to some aspects, the network, gNB and/or UE (e.g., SL UE group leader or manager) may configure the SL UE with an SL BWP inactivity timer. The expiration of this SL timer may indicate that the SL UE may not be scheduled transmission and reception for a while on the currently active SL BWP. The UE may switch its active SL BWP to a default BWP to reduce power consumption or enable power saving. The default SL BWP may be configured for NR SL. If not configured, the UE may use the initial SL BWP as the default SL BWP. Default SL BWP may be common for UEs or group of UEs. Default SL BWP may be different for UEs or different for different groups of UEs. Default SL BWP may be pre-configured for NR SL. Initial SL BWP may be the first SL BWP provided or obtained in system information during initial access.

According to some aspects, the UE may switch its active SL BWP to the default SL BWP. With dedicated RRC or PC5-RRC signaling, e.g, via Uu interface or PC5 interface, the network, gNB or another UE may configure the UE with large SL BWP, small SL BWP and SL BWP inactivity timer. The network may set the large SL BWP as the first active SL BWP and the small SL BWP as the default SL BWP. Upon RRC configuration, the first active SL BWP may become activated and may be used for scheduling a large amount of data for SL. The UE may not have traffic demand and may not have scheduled transmission for SL. The SL BWP inactivity timer may expire. The UE may switch its active SL BWP to the default SL BWP. The SL BWP configurations may be divided into common and dedicated parameters. The SL BWP-common parameters may be cell specific, implying that the network may need to ensure that the corresponding parameters are appropriately aligned across the SL UEs. The SL BWP-dedicated parameters are SL UE specific. The BWP-common parameters for a SL BWP may include basic cell-specific BWP parameters (e.g., frequency domain location, bandwidth, SCS, and cyclic prefix of this SL BWP) and additional cell-specific parameters for the PSCCH and PSSCH of this SL BWP. The BWP-dedicated parameters for a SL BWP may include UE-specific parameters for the PSCCH, PSSCH, semi-persistent scheduling and radio link monitoring configurations of this SL BWP.

According to some aspects, the first active SL BWP may be configured. When more than one UE-specific SL BWPs are configured to the UE on a serving cell, the first active SL BWP may indicate the SL BWP to be activated upon RRC (re-)configuration. The first active BWP may not be configured. In this case there may be no SL BWP switch upon RRC (re-)configuration. Switch from the initial SL BWP to another SL BWP may require RRC reconfiguration. If SCI format does not support SCI-based BWP switch, then RRC (re-)configuration, SL RRC or PC5-based RRC (re-)configuration may be used for SL BWP switching. For RRC-based SL BWP switch, there may be a delay of receiving for SL active BWP switch or transmitting for SL active BWP switch on the new SL BWP after the UE receives RRC reconfiguration involving active SL BWP switch or parameter change of its active SL BWP. With one or more additional SL BWPs being configured to a UE, the UE may be scheduled to switch the active SL BWP from one configured SL BWP to another SL BWP using SL BWP indicator in SCI format 1-A. SCI format 2-A or 2-B may also be used.

According to some aspects, SCI format 1-A may be SCI format for sidelink scheduling. Reserved bits in SCI format 1-A may be used for SL BWP indication. Reserved bits in SCI format 2-A and/or 2-B may be used for SL BWP indication. A new control filed for BWP indication may be included or configured in SCI format 1-A, SCI format 2-A or SCI format 2-B. The full set of NR SL features and their fields may be largely configurable. New SCI formats such as SCI format 1-B, SCI format 1-C, or SCI format 2-C and SCI format 2-D, may be used for sidelink scheduling and may contain SL BWP indicator field and may support SCI-based BWP switch. SL BWP field may be introduced in SCI format 1-A which may include the bitwidth of 0 to L. For example, L may be 2. The exact value may be determined by the number of RRC configured SL BWPs. The SL BWP switch delay may be dependent on SL SCS. If the SL BWP switch happens between SL BWPs of different SCS values, the switch delay requirement may be determined by the smaller SL SCS.

According to some aspects, the network, gNB or UE may configure a UE with a SL BWP inactivity timer and a default SL BWP on a serving cell. For example, the default SL BWP may be one of the SL BWPs configured to the UE and may become the active SL BWP upon expiry of the inactivity timer. If no default SL BWP is configured, the default SL BWP may be the initial SL BWP. When the timer is running, the UE may decrement the timer at the end of each time unit (e.g., each slot for FR1) or at the end of each time unit (e.g., each slot for FR2). The values for the SL BWP inactivity timer may have the range of R1 to R2 ms. For example, R1 may be 2 and R2 may be 2560. The maximum value for the SL BWP inactivity timer may match the maximum value of SL DRX inactivity timer. This may allow for a configuration that prevents the SL timer from expiring while the SL DRX inactivity timer is running. A UE may start the BWP inactivity timer of a serving cell when it activates a SL BWP other than the default SL BWP. A UE may restart the BWP inactivity timer when it decodes an SCI with SL scheduling assignment for the active SL BWP, or when it decodes an SCI with sidelink scheduling assignment for its active SL BWP of RRC configured BWPs. The inactivity timer may also be restarted when the UE transmits or receives a MAC PDU on a configured resource.

According to some aspects, a UE may start or restart the SL BWP inactivity timer when a PSCCH for SCI-based SL BWP switch is received. For timer-based SL BWP switch, the BWP switch transition time duration may be from some time unit (e.g., subframe or half-subframe for FR1 or FR2) immediately after a SL BWP inactivity timer expires until the beginning of a time unit (e.g., slot where the UE may receive or transmit). The UE may not be required to receive or transmit on the serving cell during the transition. Timer-based SL BWP switch may share the same SL BWP switch delay requirements as SCI-based SL BWP switch. A UE may have capability of receiving PSCCH and PSSCH in an active SL BWP and transmits PSCCH and PSSCH in an active SL BWP. A UE may have capability of receiving PSCCH in an inactive SL BWP. UE may support the BWP operation of one RRC configured SL BWP for transmission and reception. UE may also support the BWP operation of multiple RRC configured SL BWP for transmission and reception. UE may support the BWP operation with the BWP bandwidth restriction. UE may also support BWP operation without the BWP bandwidth restriction. Supporting bandwidth adaptation with more than one configured SL BWPs and switching among SL BWPs may be possible. UE may support bandwidth adaptation with up to M configured SL BWPs with the same numerology, or with up to J RRC configured SL BWPs with different numerologies. For example, M may be four and J may be two.

RRC-based or PC5-RRC-based SL BWP switch may be a default function supported by all UEs. SCI-based and timer-based SL BWP switches may enable efficient bandwidth adaptation and may be applicable to the UE supporting more than one RRC configured BWPs. The UE may also report which of the two switch delay requirements that it supports. Multiple BWPs may be used in NR sidelink to support flexible bandwidth operation by decoupling the channel bandwidth of a carrier from the UE channel bandwidth in NR sidelink. From the physical layer design perspective, the bandwidth of an SL BWP may span from 1 RB to 275 RBs. BWP sizes smaller than, equal to or greater than the resource block group (RBG) size or the precoding resource block group (PRG) may also be supported. Wakeup-sleep management for adaptation to SL traffic load in time and fast activation/deactivation of SL component carrier for adaptation to SL traffic load in frequency may be used.

According to some aspects, SL wakeup-sleep management and SL DRX may be beneficial for UE handling bursty data traffic by switching between network access mode and power efficient mode. Fast activation/deactivation of SL component carrier may help UE to achieve power saving by adjusting SL bandwidth processing requirements at the granularity of SL component carrier level in case of multi-carrier operation. SL BWP-based bandwidth adaptation may improve UE power efficiency by finer-granularity adaptation to traffic variation in frequency domain. SL bandwidth adaptation may be achieved by configuring the UE with multiple SL BWPs and dynamically switching the UE's active SL BWP among the configured SL BWPs. For maximizing UE power saving gain and reducing UE power consumption, SL BWP-based bandwidth adaptation may be used in conjunction with DRX and/or fast activation/deactivation of SL component carrier.

According to some aspects, NR SL may support network operation in a much wider range of spectrum with wider carrier bandwidth. NR SL may support a wide range of services and applications. They may have different requirements on throughput, latency, and reliability. SL UE devices of different bandwidth capabilities may be supported in the same NR SL network. Besides carrier aggregation for SL, the SL BWPs may be used to meet the new requirements of bandwidth flexibility in NR SL. With SL BWPs, the reception and transmission bandwidths for the UE in SL may be decoupled from SL carrier bandwidth. Switching among multiple SL BWPs for the UE may occur with UE configuration change as well. Each SL BWP has specific physical characteristics including frequency location, bandwidth, SCS and cyclic prefix. UE configuration may convey the physical characteristics of the associated SL BWP.

According to some aspects, the network may also configure SL BWPs to a UE with the same or similar physical characteristics but with different UE configurations. For example, two SL BWPs with the same physical characteristics e.g. same bandwidth, SCS may be configured to a UE with different waveforms. For example, one SL BWP may be configured with one waveform (e.g., CP-OFDM waveform) and the other SL BWP may be configured with another waveform (e.g., DFT-s-OFDM waveform). By applying SCI-based SL BWP switching among SL BWPs, the network, gNB or UE may reconfigure the UE faster than the legacy RRC reconfiguration procedure. SCI-based SL BWP switch for fast change of UE configuration may be a complementary approach limited by the maximum of M RRC configured SL BWPs. M may be four. Network may provide services with different levels of quality of service (QoS) to the same UE or different UEs in NR sidelink. SL BWPs configured with different configurations may be applied to accommodate different service requirements.

According to some aspects, to reduce UE power consumption and guarantee the data transmission rate, SL BWP may be used for NR SL. An SL BWP may be comprised of a number of continuous PRB or resource pools with specific numerology. The SL BWP may be activated or de-activated by a timer, physical layer Sidelink Control Information (SCI) signaling or higher layer RRC signaling. RRC, SCI, MAC CE and timer may be used for SL BWP activation, deactivation and switching. If configured SL BWP is one, then SL BWP indicator field is not present in SCI format. If configured SL BWP is more than one, then SL BWP indicator field is present in SCI format. SCI format may be SCI format 1-A. SCI format may be SCI format 2-A and 2-B. A new SCI format may also be used, such as SCI format 1-B, SCI format 1-X, SCI format 2-C, SCI format 2-Y or the like. An example of four configured SL BWP with SCI indicator for BWP operation for activation/deactivation/switch is depicted in Table 8.

TABLE 8
SL BWP Indicator for activation/deactivation/switch

| SL BWP | |
|---|---|
| indicator in SCI | BWP switch |
| “00” | Switch to SL BWP 1 |
| “01” | Switch to SL BWP 2 |
| “10” | Switch to SL BWP 3 |
| “11” | Switch to SL BWP 4 |

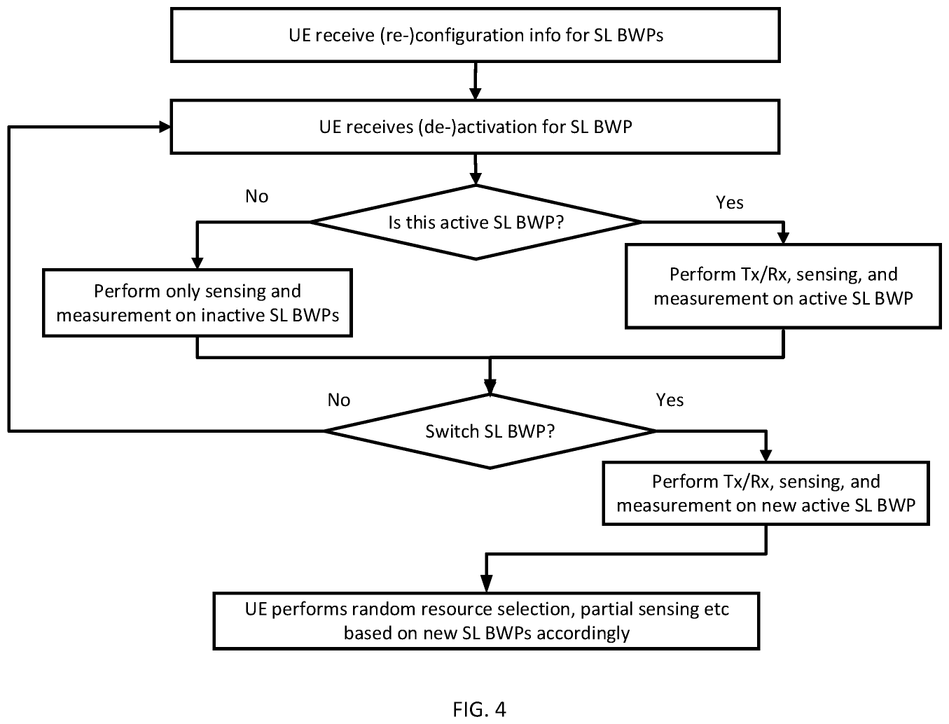

An example of SL BWP operation is depicted in FIG. 4. UE may receive configuration or reconfiguration information for SL BWP. UE may also receive activation and deactivation for SL BWP. If the SL BWP is an active BWP, then UE may perform transmission and/or reception of data. UE may perform sensing and measurement on active SL BWP. If the SL BWP is not an active BWP, then UE may not perform transmission and reception of data. Instead, UE may perform sensing/measurement on inactive SL BWP. If SL BWP is switched, the UE may perform transmission and/or reception of data, sensing/measurement on new active SL BWP. UE may perform random resource selection, partial sensing based on new SL BWP accordingly. If SL BWP is not switched, then UE may continue to check the activation/deactivation information for SL BWP.

According to some aspects, the SL BWP may be implicitly activated or de-activated based on the sidelink communication cast types, for example unicast, groupcast and broadcast. An establishment or release of a SL communication cast type may trigger the activation, deactivation, or switching of a SL BWP.

According to some aspects, a BWP may start at a certain common RB and may consist of a set of contiguous RBs with a given numerology (i.e., SCS and cyclic prefix) on a given carrier. At least one sidelink BWP may be configured. The initial SL BWP may be configured. The network, gNB or UE (e.g., UE group manager) may configure the UE with up to M SL BWPs. Only K SL BWP can be active or activated at a given time. For example, M may be four. K may be one (or two). A UE may receive PSSCH, PSCCH, PSFCH or SL CSI-RS inside an active SL BWP. UE may receive PSCCH and may perform sensing outside the active SL BWP. UE may perform SL radio resource management (RRM) measurements outside the active SL BWP. UE may transmit PSSCH inside an active SL BWP. Activating an inactive SL BWP and deactivating an active SL BWP may be performed. Different types of SL BWPs may be active or activated. Different SL BWP types may refer to different numerologies, subcarrier spacings (SCSs), CPs, waveforms, or different services, or the like.

Explicit or implicit BWP activation, deactivation or switching based on the sidelink communication cast types (e.g., unicast, groupcast and broadcast) may be possible. For example, an establishment of release of cast type may trigger the activation, deactivation, or switching of a SL BWP. It may be possible that a SL BWP indication carried in an SCI may indicate SL BWP both at the transmitter and receiver simultaneously.

Low Latency and Reduced Power Operation in SL

According to some aspects, current priority-based preemption in SL may not be efficient to handle URLLC traffic in SL since all PSSCH may not be able to transmit for a UE if its priority is lower than other UEs who intend to transmit.

According to some aspects, one solution may be to introduce SL preemption indicator (SL-PI) to preempt non-URLLC traffic. When URLLC traffic arrives, the resources in time and frequency that are occupied by URLLC traffic may be indicated to the UEs. For example, scheduling UE may send a SL-PI to RX UEs indicating the resources in time and frequency that are occupied by URLLC traffic and should be preempted by RX UEs.

In mode 2, scheduling UE may send SL-PI in SCI. Scheduling UE may send SL-PI in PSCCH or PSSCH. Scheduling UE may send SL-PI in the 1st stage SCI. Scheduling UE may send SL-PI in the 2nd stage SCI. SL-PI may be included in SCI format 1A. SL-PI may be included in SCI format 2A or SCI format 2B.

In mode 1, gNB may send SI-PI to SL TX UE. SL TX UE may send SL-PI to RX UE. gNB may send SI-PI to SL TX UE in PDCCH. SL-PI may be included in DCI format 3_0. SL TX UE may send SL-PI in SCI. SL TX UE may send SL-PI in PSCCH or PSSCH. SL TX UE may send SL-PI in the 1st stage SCI. SL TX UE may send SL-PI in the 2nd stage SCI. SL-PI may be included in SCI format 1A. SL-PI may be included in SCI format 2A or SCI format 2B.

To reduce power consumption, SL-PI may be monitored at the beginning of an SL slot where SL control occurs. According to some aspects, SL-PI may be monitored within the SL slot where sub-slot SL control can be used. Resource or resource pool may be partitioned into several partitions. Such partitions may be indicated to SL UE using, e.g., bit map. Each bit may correspond to each partition and if bit is set to “0”, then SL resource partition is not preempted. If bit is set to “1”, then SL resource partition is preempted. Different partition patterns may be used. Multiple partition patterns may be utilized. Partition pattern may be configurable. Different granularities for resource partition patterns may be used.

According to some aspects, SL-PI may be sent to UEs via groupcast or broadcast.

According to some aspects, SL cancellation indicator (SL-CI) may be used to cancel non-URLLC traffic, e.g., eMBB traffic. When URLLC traffic arrives, the resources in time and frequency that are occupied by URLLC traffic may be indicated to the UEs. For example, scheduling UE may send a SL-CI to TX UEs indicating the resources in time and frequency that are occupied by URLLC traffic and should be cancelled by TX UEs for non-URLLC transmission. In mode 2, scheduling UE may send SL-CI in SCI. Scheduling UE may send SL-CI in PSCCH or PSSCH. Scheduling UE may send SL-CI in the 1st stage SCI. Scheduling UE may send SL-CI in the 2nd stage SCI. SL-CI may be included in SCI format 1A. SL-CI may be included in SCI format 2A or SCI format 2B.

In mode 1, gNB may send SI-CI to SL TX UE. gNB may send SI-CI to SL TX UE in PDCCH or group common PDCCH. SL-CI may be included in DCI format 3_0. SL-CI may be included in DCI format 2_4. To distinguish between SL-CI and regular CI, different RNTI may be used. For example, SL-INT-RNTI may be used for SL-CI. gNB may send SL-CI using SL-INT-RNTI to a UE or a group of UEs if UEs are in coverage. According to some aspects, SL-CI may be included in a new DCI format. For example, a DCI format 2_x may be introduced and used.

To mitigate power consumption, SL-CI may be monitored at the beginning of SL slot where SL control occurs. According to some aspects, SL-CI may be monitored within the slot where sub-slot control may be used. Resource or resource pool may be partitioned into several partitions. Such partitions may be indicated to SL UE, e.g., using bitmap. Each bit may correspond to each partition and if the bit is set to “0”, then SL resource partition is not cancelled. If bit is set to “1”, then SL resource partition is cancelled. Different partition patterns for cancellation may be used. Multiple partition patterns for cancellation may be utilized. Partition pattern for cancellation may be configurable. Different granularities for resource partition patterns that are used for cancellation may be used.

According to some aspects, SL-PI may be sent to UEs via SCI, PSCCH, PSSCH, groupcast or broadcast or via PDCCH or GC-PDCCH.

To reduce the PSCCH payload size, control fields in SCI may be configurable. Control fields may be configurable in the 1st stage SCI and/or the 2nd stage SCI. Control fields may be configurable in SCI format 1A. Control fields may be configurable in SCI format 2A and/or 2B.

If SL-PI control field is configured, then UE may monitor SL-PI. UE may blind decode SCI of other UE, and check the priority control field. If priority of other UEs is higher than its own priority, then UE may discard the frequency-time resource indicated in SL-PI control field, and only receive the PSSCH in the frequency-time resource that is not indicated in SL-PI control field.

If priority of other UEs is lower than its own priority, then UE may ignore the indication in SL-PI control field, and receive the PSSCH in the frequency-time resource that is scheduled and indicated in SCI.

If SL-PI control field is not configured, then UE may blind decode SCI of other UE, and check the priority control field. If priority is higher than its priority, then UE may discard the entire frequency-time resource scheduled and indicated in SCI. UE may not receive PSSCH.

If priority of other UEs is lower than its own priority, then UE may receive the PSSCH in the frequency-time resource that is scheduled and indicated in SCI.

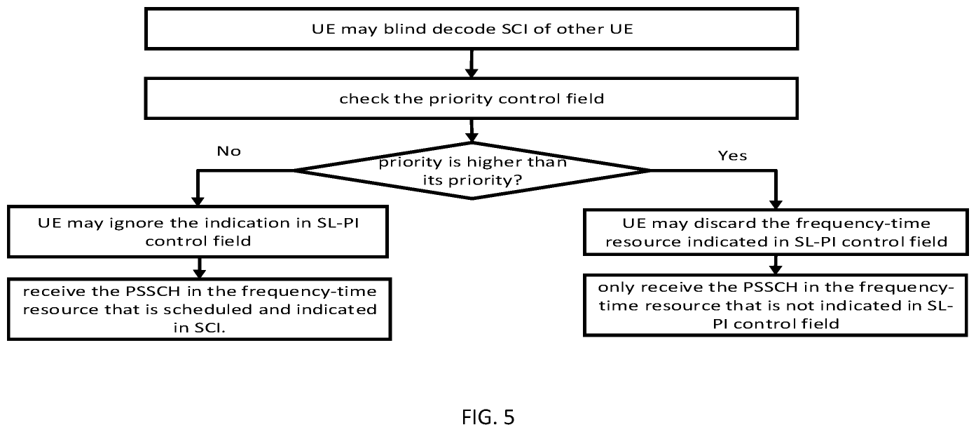

According to some aspects, a method of SL-PI is depicted in FIG. 5.

SL UE may monitor SCI of other UEs and perform blind decoding. SL UE may check the priority control field, if the priority of other UEs is higher than its own priority, then SL UE may discard the frequency-time resource that is indicated in SL-PI control field. UE may only receive PSSCH in the frequency-time resource that is not indicated in SL-PI control field. If the priority of other UEs is not higher than its own priority or lower than its own priority, then SL UE may ignore the indication in SL-PI control field. UE may receive PSSCH in the frequency-time resource that is scheduled in SCI.

If SL-PI control field is configured, then UE may monitor SL-PI. UE may blind decode SCI of other UE, and check the priority control field. If priority of other UEs is higher than its own priority, then UE may discard the frequency-time resource indicated in SL-PI control field, and only transmit the PSSCH in the frequency-time resource that is not indicated in SL-PI control field.

If priority of other UEs is lower than its own priority, then UE may ignore the indication in SL-PI control field, and transmit the PSSCH in the frequency-time resource that is scheduled and indicated in SCI.

If SL-PI control field is not configured, then UE may blind decode SCI of other UE, and check the priority control field. If priority is higher than its priority, then UE may discard the entire frequency-time resource scheduled and indicated in SCI. UE may not transmit PSSCH.

If priority of other UEs is lower than its own priority, then UE may transmit the PSSCH in the frequency-time resource that is scheduled and indicated in SCI.

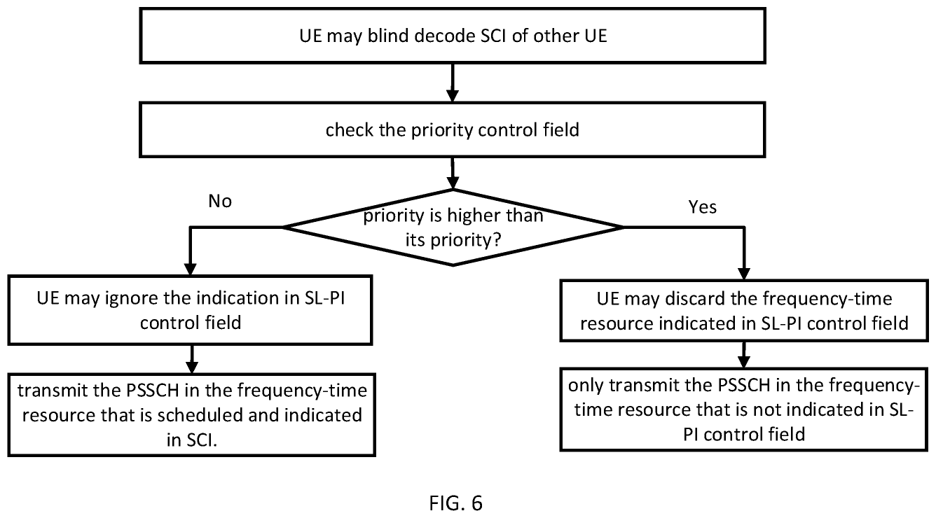

According to some aspects, a method of SL-PI is depicted in FIG. 6.

SL UE may monitor SCI of other UEs and perform blind decoding. SL UE may check the priority control field, if the priority of other UEs is higher than its own priority, then SL UE may discard the frequency-time resource that is indicated in SL-PI control field. UE may only transmit PSSCH in the frequency-time resource that is not indicated in SL-PI control field. If the priority of other UEs is not higher than its own priority or lower than its own priority, then SL UE may ignore the indication in SL-PI control field. UE may transmit PSSCH in the frequency-time resource that is scheduled in SCI.

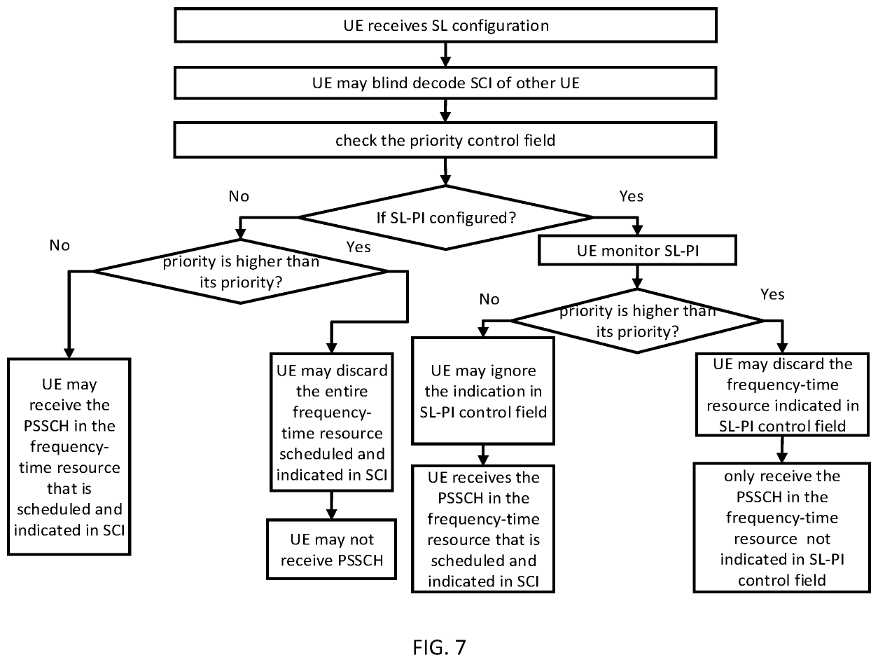

According to some aspects, a method of configurable control field for SL-PI is depicted in FIG. 7.

UE may receive SL configuration. UE may monitor and blind decode SCI of other UEs.

SL UE may check the priority control field. If SL-PI is configured, then SL UE may monitor SL-PI. If priority is higher than its own priority, then SL UE may discard the frequency-time resource that is indicated in SL-PI control field. SL UE may only receive PSSCH in frequency-time resource that is not indicated in SL-PI control field. If priority is not higher or lower than its own priority, then SL UE may ignore the frequency-time resource that is indicated in SL-PI control field. SL UE may receive PSSCH in frequency-time resource that is scheduled in SCI.

If SL-PI is not configured, then SL UE may compare the priority. If priority is higher than its own priority, then SL UE may discard the entire frequency-time resource that is scheduled in SCI. SL UE may not receive PSSCH. If priority is not higher or lower than its own priority, then SL UE may receive PSSCH in frequency-time resource that is scheduled in SCI.

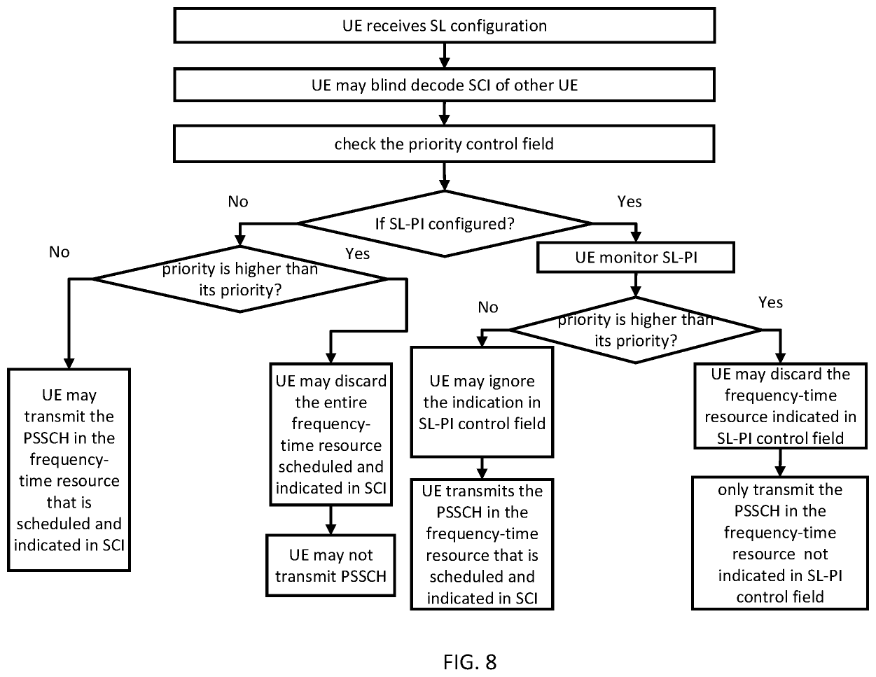

According to some aspects, a method of configurable control field for SL-PI is depicted in FIG. 8.

UE may receive SL configuration. UE may monitor and blind decode SCI of other UEs.

SL UE may check the priority control field. If SL-PI is configured, then SL UE may monitor SL-PI. If priority is higher than its own priority, then SL UE may discard the frequency-time resource that is indicated in SL-PI control field. SL UE may only transmit PSSCH in frequency-time resource that is not indicated in SL-PI control field. If priority is not higher or lower than its own priority, then SL UE may ignore the frequency-time resource that is indicated in SL-PI control field. SL UE may transmit PSSCH in frequency-time resource that is scheduled in SCI.

If SL-PI is not configured, then SL UE may compare the priority. If priority is higher than its own priority, then SL UE may discard the entire frequency-time resource that is scheduled in SCI. SL UE may not transmit PSSCH. If priority is not higher or lower than its own priority, then SL UE may transmit PSSCH in frequency-time resource that is scheduled in SCI.

According to some aspects, another solution may be to introduce SL preemption indicator (SL-PI) to preempt URLLC traffic.

The preemption indicator may take the form of a binary indicator or enumerated for, e.g., pre-empted or no pre-empt. In another embodiment, the preemption indicator may be associated with a threshold, e.g., threshold-1, configured into the UE. The receiving UE of a preemption indication maybe compare the preemption indication value to threshold-1 and determine whether or not to pre-empt the traffic, e.g., URLLC traffic associated with the SL pre-emption indicator. For example, in one another, if the preemption indicator value is lower than threshold-1, the URLLC traffic is pre-empted. In another embodiment, the UE behavior may be specified such as that if the preemption indicator value is higher than threshold-1, the URLLC traffic is pre-empted. In another embodiment, a threshold may be defined to control which traffic is preemptable and which traffic is not preemptable, e.g., threshold-2. For example, in one embodiment, any URLLC traffic associated with a preemption value below threshold-2 is not preemptable.

In another embodiment, any traffic associated with a preemption value above threshold-2, is not preemptable. In yet another embodiment, once a traffic is determined to be preemptable, a relative compassion using threahold-1 may be used to determine whether a URLLC SL traffic should be preempted by another traffic (URLLC or non-URLLC) as per the above embodiments that described the use of threshold-1. Additionally, an SL priority indicator may be introduced for admission control of sidelink traffic, e.g., URLLC traffic. A controlling UE or scheduling UE may decide to admit a traffic such as URLLC traffic or deny admission of a URLLC traffic based on the priority value of the traffic. For example, a priority threshold-3 may be configured into the controlling or scheduling UE. If the priority of the traffic is below threshold-3, the traffic is admitted. In some aspects, if the priority of the traffic is above threshold-3, the traffic is admitted.

According to some aspects, to reduce inter-UE coordination overhead, a multi-cycle coordination may be used. A first cycle coordination may indicate a large resource set, and a second coordination cycle may indicate a small set within the large resource set. The first cycle may have longer period and its information payload is large while the second cycle may have shorter period and its information payload size is small.

Different inter-UE coordination schemes may be defined. For example, inter-UE Coordination Scheme 1 may be defined where the coordination information sent from UE-A to UE-B is the set of resources preferred and/or non-preferred for UE-B's transmission. Inter-UE Coordination Scheme 2 may be defined where the coordination information sent from UE-A to UE-B is the presence of potential, expected and/or detected resource conflict on the resources indicated by UE-B's SCI. One or multiple inter-UE coordination schemes may be configured. Inter-UE coordination scheme may be enabled or disabled. Inter-UE coordination scheme may be activated or deactivated. Inter-UE coordination scheme may be switched from one to the other. Whether inter-UE coordination is enabled or disabled may be indicated. Support of inter-UE coordination may depend on UE capability. UE may also report its capability which inter-UE coordination scheme he is capable of to support. Which inter-UE coordination scheme to use may be indicated. In addition, whether or which inter-UE coordination may be used could depend on certain condition(s). For example, if collision is detected, then inter-UE coordination scheme 2 may be selected and used. Otherwise, if collision is not detected, then inter-UE coordination scheme 1 may be selected and used.

Condition(s) for which inter-UE coordination scheme (e.g., scheme 1, scheme 2, etc.) is used may include but not limited to the following:
(1) Preferred resource set and non-preferred resource set based on sensing results or the like;
(2) Sensing results or the like:
(3) Interference level;
(4) CBR/CR;
(5) HARQ feedback (ACK, NACK);
(6) Power;
(7) Reliability;
(8) Latency;
(9) Overhead;
(10) Complexity;
(11) Payload size;
(12) Cast type is (unicast, groupcast, broadcast);
(13) HARQ-based or blind retransmission;
(14) Capability;
(15) Configuration or pre-configuration;
(16) Congestion level;
(17) QoS; and
(18) Priority (L1 priority, higher layer priority, or the like).

According to some aspects, the impact of DRX on physical layer sensing and resource selection including sensing procedures and resource selection and reselection procedures may be considered. DRX ON and OFF duration may be considered for physical layer sensing and resource selection and reselection procedures.

For example, if it is on DRX ON duration, UE may perform sensing or measurement, PSCCH control monitoring and PSSCH data reception. As another example, if it is on DRX OFF duration, UE is not required to perform reception. Thus, UE may not (or is not required to) perform PSCCH control monitoring and PSSCH data reception for its own UE. But UE may perform sensing or measurement from other UEs.

UE may perform periodic-based or contiguous partial sensing during DRX OFF duration. If UE decodes PSCCH (e.g., 1st stage and 2nd stage) of its own UE during ON duration, then inactivity timer may be started. UE may decode PSSCH.

If UE decodes PSCCH (e.g., 1st stage and 2nd stage) of other UE during ON duration, then inactivity timer may or may not be started. Sensing-based inactivity timer for sensing may be used to enhance sensing accuracy. UE may not decode PSSCH.

If UE decodes PSCCH (e.g., 1st stage and 2nd stage) of its own during OFF duration, then this may be considered as an error case. Since gNB or TX UE may not send during OFF duration (and RX UE is not required to monitor PSCCH).

If UE decodes PSCCH (e.g., 1st stage and/or 2nd stage) of other UEs during OFF duration, then inactivity timer may (or may not) be started. If inactivity timer is started, it may be used to enhance sensing accuracy. A sensing-based inactivity timer may be introduced. UE may not decode PSSCH. Since it may not be expected to receive the 2nd stage SCI and PSSCH, UE may not decode the 2nd stage SCI and PSSCH.

Methods and procedures to decide the 1st stage SCI or the 2nd stage SCI may be based on DRX ON and OFF duration. If UE is on DRX ON duration, UE may use both the 1st stage SCI and the 2nd stage SCI. If UE is on DRX OFF duration, UE may use the 1st stage SCI.

UE may receive (re-)configuration information for SL resources. UE may also receive DRX configuration for SL. If it is in DRX ON duration, UE may perform decoding of the 1st stage SCI, 2nd stage SCI and PSSCH for its own data. UE may also perform decoding of the 1st stage SCI for other UEs. If it is in DRX OFF duration, UE may perform decoding of the 1st stage SCI for other UEs.

Another solution may be to introduce a sensing-based inactivity timer (SIT). Sensing-based inactivity timer may be used in combination with regular data inactivity timer (DIT).

UE may receive (re-)configuration information for SL resources. UE may also receive DRX configuration for SL. If it is in DRX ON duration, UE may perform decoding of the 1st stage SCI, 2nd stage SCI and PSSCH for its own data. UE may also perform decoding of the 1st stage SCI for other UEs. If this PSCCH is for other UEs, then UE may start the sensing inactivity timer (SIT). UE may perform contiguous or periodic-based partial sensing accordingly. If this PSCCH is not for other UEs but for its own, then UE may decode the PSSCH.

If it is in DRX OFF duration, then UE may perform decoding of the 1st stage SCI for other UEs. UE may start SIT.

According to some aspects, UE may receive (re-)configuration information for SL resources. UE may also receive DRX configuration for SL. If it is in DRX ON duration, UE may perform decoding of the 1st stage SCI, 2nd stage SCI and PSSCH for its own data. UE may also perform decoding of the 1st stage SCI for other UEs. If this PSCCH is for other UEs, then UE may start the sensing inactivity timer (SIT). UE may perform contiguous or periodic-based partial sensing accordingly. If this PSCCH is not for other UEs but for its own data, then UE may decode the PSSCH. UE my start data inactivity timer (DIT).

If it is in DRX OFF duration, then UE may perform decoding of the 1st stage SCI for other UEs. UE may start SIT only. In this case, UE may not start DIT. If the 1st stage SCI is detected before sensing inactivity timer expires, then UE may perform decoding of the 1st stage SCI for other UEs. If the 1st stage SCI is detected before sensing inactivity timer expires, then UE may go to sleep until next DRX ON cycle. UE may perform contiguous or periodic-based partial sensing accordingly.

Methods and procedures to use SCI format 1-A or use SCI format 2-A or 2-B may be based on DRX ON and OFF duration. If UE is on DRX ON duration, UE may use SCI format 1-A and SCI format 2-A or 2-B. If UE is on DRX OFF duration, UE may use only SCI format 1-A. Yet another solution may be to have sensing procedure with trigger of PSCCH monitoring during DRX OFF state. Conditions(s) for triggering may be used. Conditions may include but not limited to the following:
(1) Preferred resource set and non-preferred resource set based on sensing results or the like;
(2) Sensing results or the like;
(3) Interference level;
(4) CBR/CR;
(5) HARQ feedback (ACK, NACK);
(6) Power;
(7) Reliability;
(8) Latency;
(9) Overhead;
(10) Complexity;
(11) Payload size;
(12) Cast type is (unicast, groupcast, broadcast);
(13) HARQ-based or blind retransmission;
(14) Capability;
(15) Configuration or pre-configuration;
(16) Congestion level;
(17) QoS; and
(18) Priority (L1 priority, higher layer priority, or the like).

Different case types such as groupcast, unicast and broadcast may be considered. The following conditions may be considered for trigger of PSCCH monitoring:
(1) QoS, PQI, or the like;
(2) PPPR, PPPP, or the like;
(3) Service priority, traffic priority, signal priority, L1 priority, higher priority or the like; and
(4) Priority of cast type.

Sensing may be performed during OFF duration based on priority of cast type, service type, traffic type, or the like.

The following timers may be considered and used:
(1) DRX On duration timer, inactivity timer, sensing-based timer, sensing-based inactivity timer, or the like; and
(2) DRX active time (receive PSCCH/PSSCH), DRX partial active time (receive SCI only), DRX partial active time 2 (receive 1st stage SCI only), or the like.

The following sensing procedure may be performed:
(1) UE may perform sensing during ON duration, perform resource selection during another ON duration, and receive PSSCH during yet another ON duration;
(2) UE may perform sensing during ON duration, perform resource selection during OFF duration, and receive PSSCH during another ON duration;
(3) UE may perform sensing during OFF duration, perform resource selection during ON duration, and receive PSSCH during another ON duration;
(4) UE may perform sensing during OFF duration, perform resource selection during another OFF duration, and receive PSSCH during ON duration;
(5) Sensing, resource selection window and DRX ON/OFF may or may not be aligned (e.g., Option 1: aligned, Option 2: not aligned);
(6) UE may perform sensing during ON duration, perform resource selection during another ON duration, perform resource reselection during another ON duration and receive PSSCH during yet another ON duration;
(7) UE may perform sensing during ON duration, perform resource selection during another ON duration, perform resource reselection during OFF duration and receive PSSCH during yet another ON duration;
(8) UE may perform sensing during ON duration, perform resource selection during another OFF duration, perform resource reselection during ON duration and receive PSSCH during yet another ON duration;
(9) UE may perform sensing during ON duration, perform resource selection during another OFF duration, perform resource reselection during OFF duration and receive PSSCH during yet another ON duration;
(10) UE may perform sensing during OFF duration, perform resource selection during another ON duration, perform resource reselection during another ON duration and receive PSSCH during yet another ON duration;
(11) UE may perform sensing during OFF duration, perform resource selection during another ON duration, perform resource reselection during another OFF duration and receive PSSCH during yet another ON duration;
(12) UE may perform sensing during OFF duration, perform resource selection during another OFF duration, perform resource reselection during another ON duration and receive PSSCH during yet another ON duration;
(13) UE may perform sensing during OFF duration, perform resource selection during another OFF duration, perform resource reselection during another OFF duration and receive PSSCH during yet another ON duration (e.g., sensing window, resource selection window, resource reselection window may be aligned, partially aligned or not aligned with data decoding window) (e.g., sensing window, resource selection window, resource reselection window may be aligned, partially aligned or not aligned with DRX ON window and/or DRX OFF window); and
(14) DRX OFF duration—UE may a) trigger to monitor SCI based on conditions, b) continue monitoring SCI c) continue monitoring SCI based on sub-ON period inside OFF duration where sub-ON period is predefined, (pre-) configured, d) based on priority, QoS, power saving criteria, latency requirement, etc. to monitor SCI inside OFF duration.

The following sensing method and procedure during OFF duration may be considered and may choose or indicate to perform either one or more of the following:
(A) perform PSCCH-based sensing (preemption indicator-based only);
(B) perform measurement-based sensing (PSCCH-DMRS-only, PSSCH-DMRS-only, PSCCH/PSSCH-DMRS);
(C) perform both (A) and (B); and
(D) During ON duration, perform (C).

Resource exclusion methods and procedures may use the following:
(1) Priority lower and RSRP lower;
(2) Priority lower and RSRP higher;
(3) Priority lower;
(4) Priority lower than a threshold;
(5) Priority lower than a threshold, and lower than preempting UE;
(6) RSRP higher;
(7) Both; and
(8) All.

Resource exclusion methods and procedures may interact with DRX ON/OFF duration.

Resource selection methods and procedures may use the following:
(1) UE may perform resource selection or reselection during ON duration and receive PSSCH during another ON duration where PSSCH can be received; and
UE may perform resource selection or reselection during OFF duration and receive PSSCH during ON duration.

Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

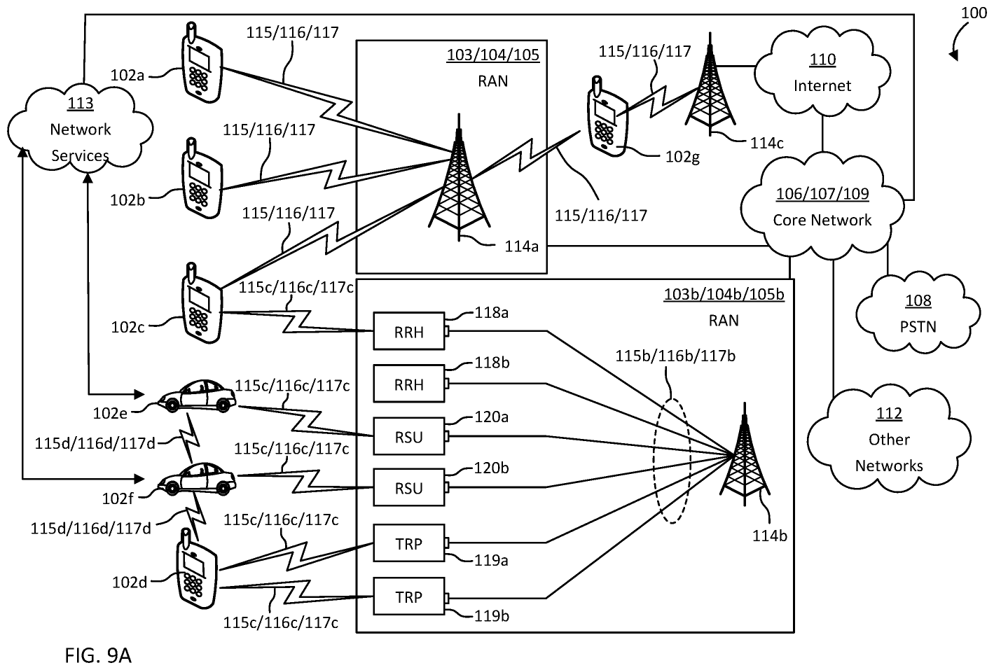

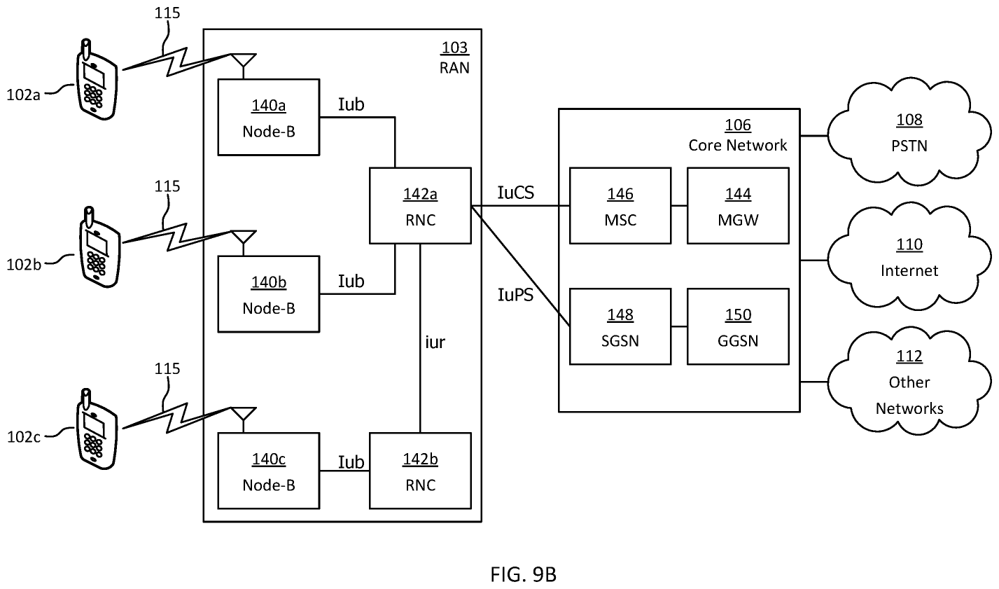

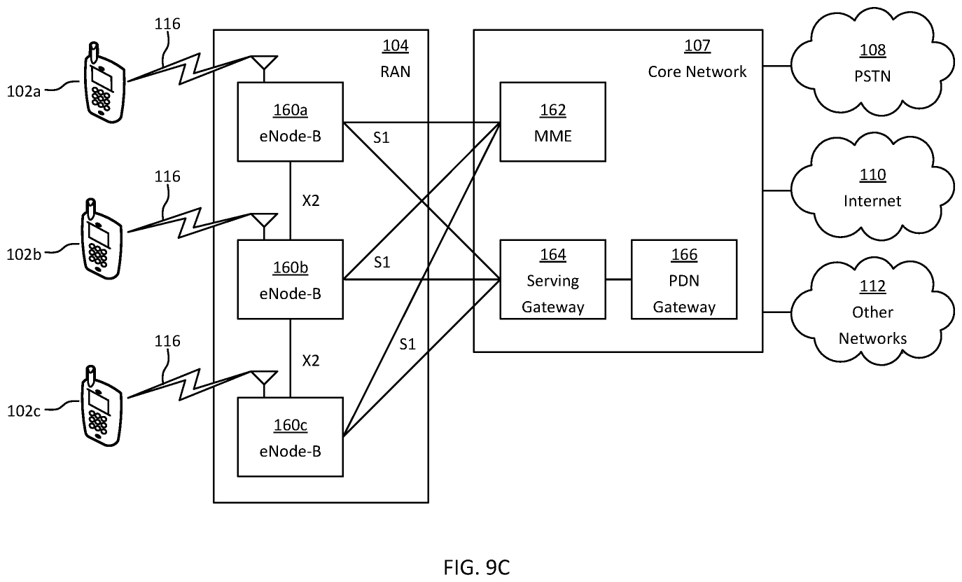

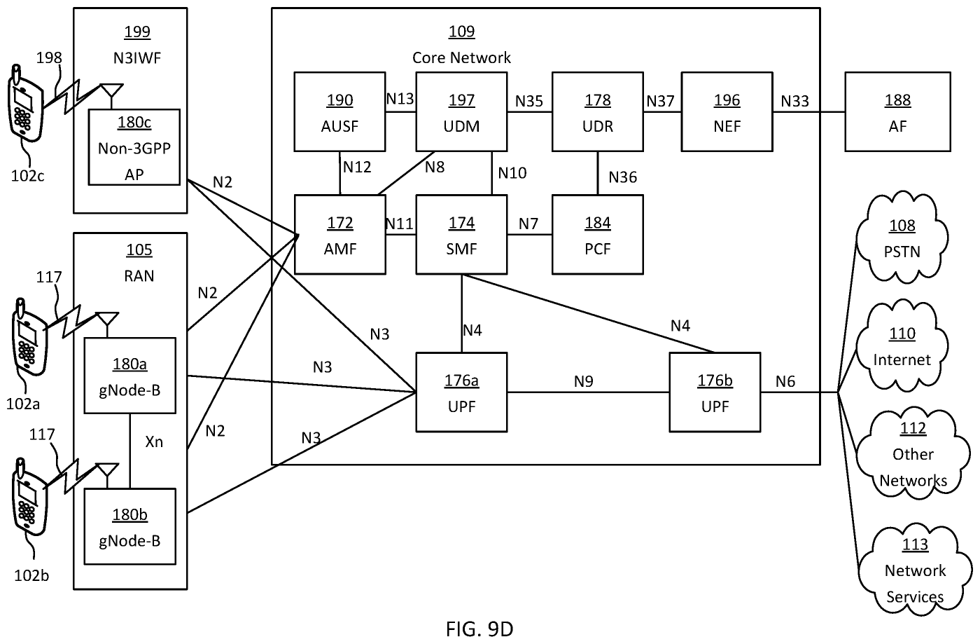

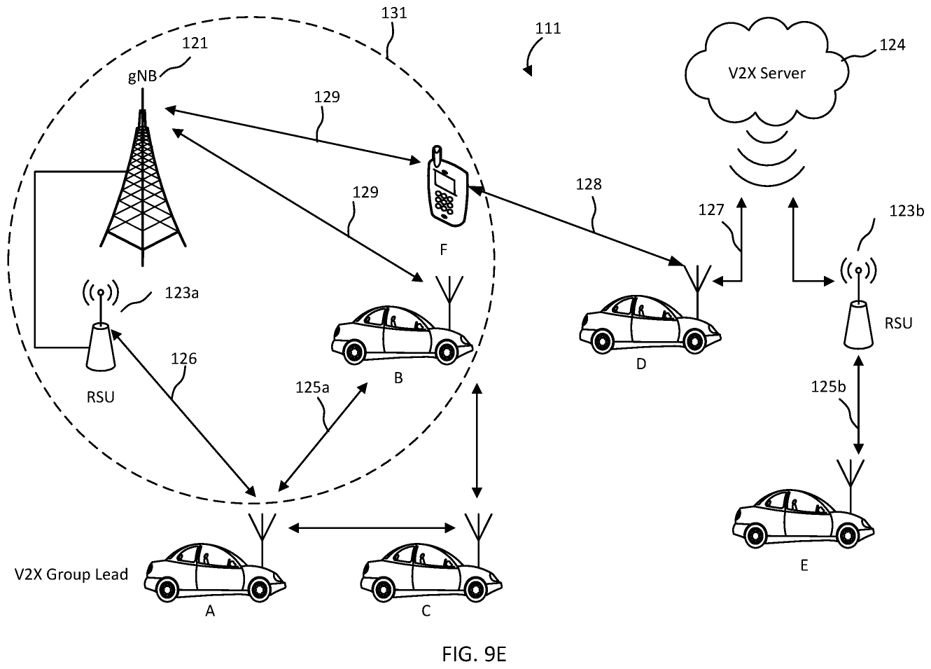

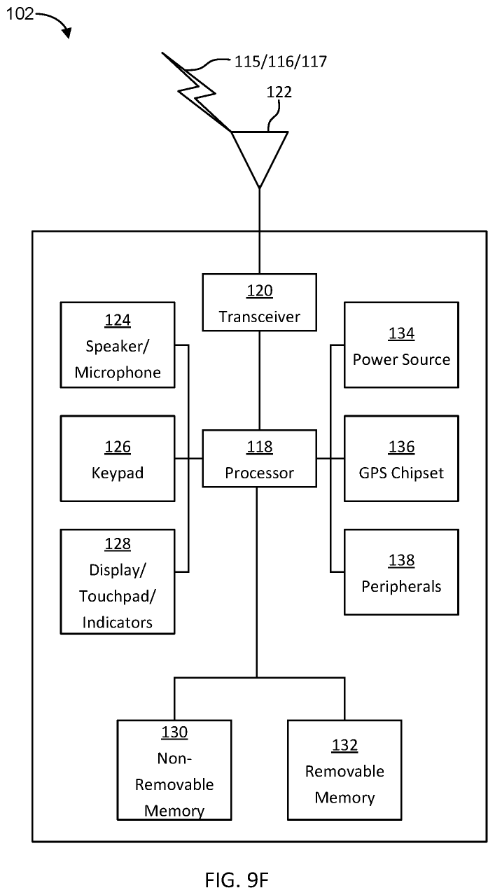

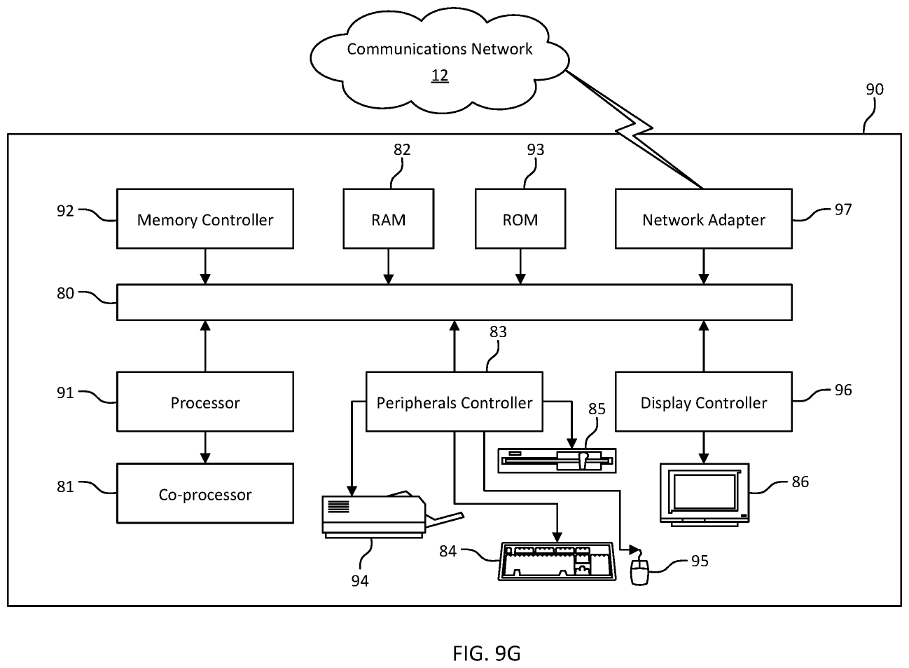

FIG. 9A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/109B, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 9A, each of the WTRUs 102 is depicted in FIGS. 9A-9E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and abase station 114b. In the example of FIG. 9A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 119A, 119B, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 119A, 119B may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/109B, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 119A and 119B, TRPs 119a and 119b, and/or RSUs 120a and 120b, over a wired or air interface 119B/116b/119B, which may be any suitable wired (e.g., cable, optical fiber, etc.) or wireless communication link (e.g., RF, microwave, IR, UV, visible light, cmWave, mmWave, etc.). The air interface 119B/116b/119B may be established using any suitable RAT.

The RRHs 119A, 119B, TRPs 119a, 119b and/or RSUs 120a, 120b, may communicate with one or more of the WTRUs 102c, 102d, 102e, 102f over an air interface 119C/116c/119C, which may be any suitable wireless communication link (e.g., RF, microwave, IR, ultraviolet UV, visible light, cmWave, mmWave, etc.) The air interface 119C/116c/119C may be established using any suitable RAT.

The WTRUs 102 may communicate with one another over a direct air interface 119D/116d/119D, such as Sidelink communication which may be any suitable wireless communication link (e.g., RF, microwave, IR, ultraviolet UV, visible light, cmWave, mmWave, etc.) The air interface 119D/116d/119D may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 119A, 119B, TRPs 119a, 119b and/or RSUs 120a and 120b in the RAN 103b/104b/109B and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 119C/116c/119C respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 119A and 119B, TRPs 119a and 119b, and/or RSUs 120a and 120b in the RAN 103b/104b/109B and the WTRUs 102c, 102d, may implement a radio technology such as Evolved UMTS Terrestrial Radio Access (E-UTRA), which may establish the air interface 115/116/117 or 119C/116c/119C respectively using Long Term Evolution (LTE) and/or LTE-Advanced (LTE-A), for example. The air interface 115/116/117 or 119C/116c/119C may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 119A and 119B, TRPs 119a and 119b, and/or RSUs 120a and 120b in the RAN 103b/104b/109B and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 9A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 9A, the base station 114c may have a direct connection to the Internet 110. Thus, the base station 114c may not be required to access the Internet 110 via the core network 106/107/109.

The RAN 103/104/105 and/or RAN 103b/104b/109B may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 9A, it will be appreciated that the RAN 103/104/105 and/or RAN 103b/104b/109B and/or the core network 106/107/109 may be in direct or indirect communication with other RANs that employ the same RAT as the RAN 103/104/105 and/or RAN 103b/104b/109B or a different RAT. For example, in addition to being connected to the RAN 103/104/105 and/or RAN 103b/104b/109B, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/109B or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 9A may be configured to communicate with the base station 114a, which may employ a cellular-based radio technology, and with the base station 114c, which may employ an IEEE 802 radio technology.

Although not shown in FIG. 9A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 119C/116c/119C may equally apply to a wired connection.

FIG. 9B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 9B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 9B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 9B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 9C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 9C, the eNode-Bs 160a, 160b, and 160c may communicate with one another over an X2 interface.

The core network 107 shown in FIG. 9C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 9D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 9D, the gNode-Bs 180a and 180b may communicate with one another over an Xn interface, for example.

The core network 109 shown in FIG. 9D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 9G.

In the example of FIG. 9D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 9D shows that network functions directly connect to one another, however, it should be appreciated that they may communicate via routing agents such as a diameter routing agent or message buses.

In the example of FIG. 9D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 9D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 9D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 9D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 9A, 9C, 9D, and 9E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 9A, 9B, 9C, 9D, and 9E are provided by way of example only, and it is understood that the subject matter disclosed and claimed herein may be embodied or implemented in any similar communication system, whether presently defined or defined in the future.

FIG. 9E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 9E, WTRUs B and F are shown within access network coverage 131. WTRUs A, B, C, D, E, and F may communicate with each other directly via a Sidelink interface (e.g., PC5 or NR PC5) such as interface 129A, 129B, or 128, whether they are under the access network coverage 131 or out of the access network coverage 131. For instance, in the example of FIG. 9E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 129B. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 9F is a block diagram of an example apparatus or device WTRU 102 that may be configured for wireless communications and operations in accordance with the systems, methods, and apparatuses described herein, such as a WTRU 102 of FIG. 9A, 9B, 9C, 9D, or 9E. As shown in FIG. 9F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 9F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 9F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 9A) over the air interface 115/116/117 or another UE over the air interface 119D/116d/119D. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 9F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132.

The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 9G is a block diagram of an exemplary computing system 90 in which one or more apparatuses of the communications networks illustrated in FIGS. 9A, 9C, 9D and 9E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 9A, 9B, 9C, 9D, and 9E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1-20. (canceled)

21. A wireless transmit/receive unit (WTRU), comprising a transceiver and one or more processors, configured to:
receive coordination information from a Medium Access Control (MAC) Control Element (CE) or sidelink control information (SCI) for a plurality of sidelink (SL) bandwidth parts (BWPs);
determine, based on the coordination information for the plurality of SL BWPs, an indication of one or more active BWPs;
transmit, based on the one or more active BWPs, data using a first resource type;
determine, based on the coordination information for the plurality of SL BWPs, an indication of one or more inactive BWPs; and
perform, based on the one or more inactive BWPs, measurement or sensing using a second resource type that is different than the first resource type.

22. The WTRU of claim 21, further configured to:
determine, based on the coordination information for the plurality of SL BWPs, an indication to switch to a different active BWP; and
perform, based on the switch to the different active BWP, transmission of data using the first resource type.

23. The WTRU of claim 22, wherein the indication of the active one or more BWPs, the indication of the one or more inactive BWPs, and the switch to the different active BWP are based on an SL BWP indicator.

24. The WTRU of claim 21, further configured to transmit a priority order, wherein the coordination information is based on the priority order.

25. The WTRU of claim 24, wherein the priority order is carried by the MAC CE or the SCI.

26. The WTRU of claim 24, wherein the priority order is based at least in part on reducing power consumption, increasing reliability, or decreasing latency.

27. The WTRU of claim 21, further configured to select, based on the coordination information for the plurality of SL BWPs, the first resource type from a type of resources set.

28. The WTRU of claim 27, wherein the type of resources set comprises one or more of a preferred resource type, a non-preferred resource type, or a resource conflict resource type.

29. The WTRU of claim 27, further configured to determine a Physical Sidelink Control Channel (PSSCH) payload size, wherein the type of resources set is based at least in part on the PSSCH payload size.

30. The WTRU of claim 27, wherein the coordination information comprises a collision indicator and the WTRU is further configured to determine, based on the collision indicator, a resource collision, and the type of resources set is based at least in part on the resource collision determination.

31. The WTRU of claim 27, wherein the coordination information comprises an indicator for sensing and resource allocation type and the WTRU is further configured to determine, based on the indicator, one or more sensing operations, and the type of resources set is based at least in part on the one or more sensing operations.

32. The WTRU of claim 21, wherein the coordination information comprises an indicator and wherein the indicator comprises information associated with power status, or power saving mode.

33. A method performed by a wireless transmit/receive unit (WTRU), the method comprising:
receiving coordination information from a Medium Access Control (MAC) Control Element (CE) or sidelink control information (SCI) for a plurality of sidelink (SL) bandwidth parts (BWPs);
determining, based on the coordination information for the plurality of SL BWPs, an indication of one or more active BWPs;
transmitting, based on the one or more active BWPs, data using a first resource type;
determining, based on the coordination information for the plurality of SL BWPs, an indication of one or more inactive BWPs; and
performing, based on the one or more inactive BWPs, measurement or sensing using a second resource type that is different than the first resource type.

34. The method of claim 33, further comprising:
determining, based on the coordination information for the plurality of SL BWPs, an indication to switch to a different active BWP; and
performing, based on the switch to the different active BWP, transmission of data using the first resource type.

35. The method of claim 34, wherein the indication of the active one or more BWPs, the indication of the one or more inactive BWPs, and the switch to the different active BWP are based on an SL BWP indicator.

36. The method of claim 33, further comprising transmitting a priority order, wherein the coordination information is based on the priority order.

37. The method of claim 33, further comprising selecting, based on the coordination information for the plurality of SL BWPs, the first resource type from a type of resources set.

38. The method of claim 37, wherein the coordination information comprises a collision indicator and the WTRU is further configured to determine, based on the collision indicator, a resource collision, and the type of resources set is based at least in part on the resource collision determination.

39. The method of claim 37, wherein the coordination information comprises an indicator for sensing and resource allocation type and the WTRU is further configured to determine, based on the indicator, one or more sensing operations, and the type of resources set is based at least in part on the one or more sensing operations.

40. A system comprising:
one or more processors; and
memory coupled with the one or more processors, the memory storing executable instructions that when executed by the one or more processors cause the one or more processors to effectuate operations comprising:
receiving coordination information from a Medium Access Control (MAC) Control Element (CE) or sidelink control information (SCI) for a plurality of sidelink (SL) bandwidth parts (BWPs);
determining, based on the coordination information for the plurality of SL BWPs, an indication of one or more active BWPs;
transmitting, based on the one or more active BWPs, data using a first resource type;
determining, based on the coordination information for the plurality of SL BWPs, an indication of one or more inactive BWPs; and
performing, based on the one or more inactive BWPs, measurement or sensing using a second resource type that is different than the first resource type.
